(19) United States
(12) Patent Application Publication
(10) Pub. No.: US 2019/0194500 A1
(43) Pub. Date: Jun. 27, 2019

(54) IONIZING RADIATION CROSSLINKABLE TACKIFED (METH)ACRYLATE (CO)POLYMER PRESSURE SENSITIVE ADHESIVES WITH LOW ACID CONTENT

(71) Applicant: 3M INNOVATIVE PROPERTIES COMPANY, St. Paul, MN (US)

(72) Inventors: Petra M. STEGMAIER, Duesseldorf (DE); Francois C. D'HAESE, Antwerp (BE); Stijn A.M. D'HOLLANDER, Sint-Niklaas (BE); Sasha B. MYERS, Arden Hills, MN (US); Ryan B. PRINCE, St. Paul, MN (US)

(73) Assignee: 3M Innovative Properties Company, St. Paul, MN (US)

(21) Appl. No.: 16/310,030

(22) PCT Filed: Jun. 28, 2017
(86) PCT No.: PCT/US2017/039630

§ 371 Date: Dec. 14, 2018

Related U.S. Application Data
(60) Provisional application No. 62/357,035, filed on Jun. 30, 2016.
(60) Provisional application No. 62/356,384, filed on Jun. 29, 2016.

(51) Int. Cl. C09J 7/38; C09J 4/06; C09J 133/06; C08F 2/52; C08F 220/18

(52) U.S. Cl. CPC C09J 7/385; C09J 4/06; C09J 133/06; C08L 33/06; C08F 220/18; C09J 2205/114; C08L 2312/06; C08F 2/52

(57) ABSTRACT

Ionizing radiation crosslinkable pressure sensitive adhesive precursors containing hydrocarbon tackifiers and having an acid content of no more than 3% by weight. The precursors can be exposed to a source of ionizing radiation, for example, one or both of an electron beam or gamma radiation, for an exposure time sufficient to receive an energy dose sufficient to at least partially crosslink the adhesive precursor, thereby forming a pressure sensitive adhesive. Methods of using ionizing radiation to crosslink a crosslinkable pressure sensitive adhesive precursor are also disclosed.

### FIELD

The present disclosure relates generally to the field of adhesives, more specifically pressure sensitive adhesives, and more particularly ionizing radiation crosslinked pressure sensitive adhesives (PSAs) containing relatively high levels of tackifying agents and having low acid content. Methods of making such crosslinked PSAs are also described.

### BACKGROUND

Adhesives have been used for a variety of marking, holding, protecting, sealing and masking purposes. Adhesive tapes generally comprise a backing, or substrate, and an adhesive. One type of adhesive, a pressure sensitive adhesive, is particularly preferred for many applications. Pressure sensitive adhesives are well known to one of ordinary skill in the art to possess certain properties at room temperature including the following: (1) aggressive and permanent tack, (2) adherence with no more than finger pressure, (3) sufficient ability to hold onto an adherend, and (4) sufficient cohesive strength.

Materials that have been found to function well as pressure sensitive adhesives are polymers designed and formulated to exhibit the requisite viscoelastic properties resulting in a desired balance of tack, peel adhesion, and shear strength. The most commonly used polymers for preparation of pressure sensitive adhesives are natural rubber, synthetic rubbers (e.g., styrene/butadiene copolymers (SBR) and styrene/isoprene/styrene (SIS) block copolymers), various (meth)acrylate (e.g., acrylate and methacrylate) copolymers and silicones.

General purpose tapes which stick to all types of surfaces and especially pressure sensitive adhesives which stick very well to Low Surface Energy (LSE) substrates typically require addition of high amounts of tackifying resins. PSA's prepared from solution (co)polymer may compensate for the reduced cohesive strength, due to the presence of low molecular weight tackifying resin, with appropriate addition of crosslinkers or increased molecular weight of the (co)polymer. It is known that crosslinking produces (co)polymer networks which have quite different mechanical and physical properties compared to their uncrosslinked linear or branched counterparts. For example, (co)polymer networks can show such unique and highly desirable properties as solvent resistance, high cohesive strength, and elastomeric character. Crosslinked polymers can be made in situ during formation of the desired (co)polymer product. Many patents are known describing techniques to achieve efficient crosslink mechanisms and good cohesive strength properties.

PSAs can be applied to substrates by solvent and hot-melt coating techniques. Although solvent coating techniques are widely used, hot-melt coating techniques may provide some environmental and economical advantages. However, unlike solvent coating techniques where the (co)polymer coating and crosslinking are performed simultaneously, hot-melt coating generally requires that coating and crosslinking be performed sequentially. This is due to competing considerations: a (co)polymer should not be highly crosslinked if it is to be hot-melt coated smoothly, yet the (co)polymer needs to be crosslinked to achieve certain desirable performance properties such as e.g. high shear when the (co)polymer is a PSA. Therefore, hot-melt coating is generally performed prior to crosslinking of the coated (co)polymer.

In hot melt processable formulations, however, the (co)polymer has to be able to flow sufficiently at extruder temperature and therefore the maximum molecular weight and extent of crosslinking during processing is generally limited to levels which yield poor adhesive properties. Consequently, hot melt processable adhesive formulations often require a thermally-induced curing step within the extruder, or a post-curing step after extrusion, in order to increase the molecular weight and form sufficient crosslinks to make a useful PSA. Nevertheless, the use thermal crosslinkers to create a higher cohesive strength via an increase of the molecular weight and the creation of a chemical network is not always practical, because of the potential to increase the viscosity of the formulation to unprocessable levels due to thermal initiation of crosslinking during hot melt processing.

Some of the problems associated with solvent and bulk processing of crosslinked materials, or thermally-induced crosslinking of thermally crosslinkable materials, have been avoided through the use of actinic (i.e. ultraviolet, visible or infrared light) radiation processing. U.S. Pat. No. 4,379,201 (Heilmann et al.) discloses an example of a class of polyacrylic-functional crosslinkers used in the photocuring of (meth)acrylate copolymers. U.S. Pat. No. 4,391,687 (Vesley) and U.S. Pat. No. 4,330,590 (Vesley) describe a class of fast curing triazine photocrosslinkers which, when mixed with an acrylic monomer and, optionally, a monoethylenically unsaturated monomer, and exposed to ultraviolet radiation, forms a crosslinked polyacrylate. The crosslinks formed by both the (meth)acrylates and the triazines in these copolymerizations prevent any further processing, such as hot melt coating, reactive extrusion, or solution coating processes, following the initial photopolymerization. However, since further processing of the (co)polymer product is often necessary, it is more typical to start from the linear or branched (co)polymer which, in the final processing step, is cured to a crosslinked material. The curing or crosslinking step is typically activated by moisture, thermal energy or actinic radiation (i.e., ultraviolet, visible, or infrared light). The latter has found widespread applications, particularly in the use of ultraviolet (UV) light as the radiation source.

In the past, a variety of different materials have been used as crosslinking agents with actinic radiation (i.e., ultraviolet, visible, or infrared light) curing or crosslinking, e.g. polyfunctional acrylates, acetophenones, benzophenones, and triazines. The foregoing crosslinking agents may however possess certain drawbacks which include one or more of the following: high volatility; incompatibility with certain (co)polymer systems; generation of corrosive or toxic by-products; generation of undesirable color; requirement of a separate photoactive compound (i.e., a photoinitiator) to initiate the crosslinking reaction and high sensitivity to oxygen.

U.S. Pat. No. 4,737,559 (Kellen et al.) discloses a PSA which is a copolymer of an acrylate monomer and a copolymerizable mono-ethylenically unsaturated aromatic ketone comonomer free of ortho-aromatic hydroxyl groups. WO-A1-97/40090 (Stark et al.) describes an UV radiation crosslinkable composition comprising: a) a radiation crosslinkable (co)polymer having abstractable hydrogen atoms and UV radiation-activatable crosslinking groups capable of abstracting hydrogen atoms when activated; and b) a non-polymerizable UV radiation-activatable crosslinking agent capable of abstracting hydrogen atoms when activated. WO-A1-96/35725 (ANG) discloses pigmented, UV-crosslinked, acrylic-based, pressure sensitive adhesives claimed to have high cohesive strength and high-temperature shear resistance. The adhesives disclosed in WO-A1-96/35725 comprise an acrylic copolymer compounded with a pigment and a hydrogen-abstracting photoinitiator, wherein the acrylic copolymer is obtained by copolymerizing an alkyl acrylate and a tertiary amine-containing monomer. WO-A1-2012/044529 (Satrijo et al.) describes a hot-melt processable PSA comprising: a) a hot-melt processable elastomeric (meth)acrylate random (co)polymer; b) at least one tackifying resin comprising greater than 50 parts by weight per 100 parts by weight of elastomeric (meth)acrylate random (co)polymer; and c) a thermoplastic material.

### SUMMARY

The use of photoinitiators to effect actinic radiation (e.g., UV) crosslinking or curing can compromise or otherwise affect the properties and purity of the crosslinked material, particularly when used as a pressure sensitive adhesive layer. Determining the optimal concentration of photoinitiator, particularly in thicker PSA layers, often requires making concessions between critical factors such as (co)polymerization or crosslinking rate, curing at the surface or the bulk curing of the coating, and/or limiting the level of unreacted or residual monomers or photoinitiators.

For example, lower photoinitiator levels tend to reduce residual photoinitiator content and allow the penetration of light through the depth of the coating, but also reduce the cure rate of the coating or film. Higher photoinitiator levels promote rapid cure rate and surface cure of photopolymerized pressure sensitive adhesives, but potentially lead to incomplete (co)polymerization or low crosslinking of the PSA, and thus unacceptably high levels of residual monomers or other reactants, including the photoinitiator itself. The presence of such residual photoinitiators and photoinitiator by-products affects both the potential commercial applications and long term stability of photopolymerized pressure sensitive adhesives made in this manner.

Additionally, because hot-melt coating techniques involve high amounts of thermal energy and shear, the subsequent crosslinking procedure usually involves non-thermal energy sources. Electron beam (e-beam) and ultraviolet (UV) energy sources have been used, although e-beam techniques often are too energy intensive to be practical. Accordingly, much interest has been focused on UV radiation crosslinking of polymers.

Also, when a tackifying resin is present in the PSA formulation, especially in a relatively high amount, a large fraction of the exposed UV light during the crosslinking step is absorbed by the tackifying resin/photocrosslinker system which may result in reduced crosslinking efficiency and poor cohesive strength of the resulting PSA. When UV radiation is used to crosslink tackified PSA formulations, the tackifying resin may provoke several other deleterious effects such as e.g. undesired chain transfer or chain termination reactions.

The use of high levels of tackifying agent(s) may be desirable because it can increase the tackiness of the pressure sensitive adhesive, making it aggressively adhere to wide range of substrates. The addition of tackifying resin, especially high levels of tackifying resin, may detrimentally affect the shear and cohesive strength of a pressure sensitive adhesive, and may even raise the glass transition temperature (T_{g}) of the adhesive. The use of high levels of tackifying resin may be particularly detrimental to hot melt processable pressure sensitive adhesives.

High levels of hydrocarbon tackifying resin can also be desirable because tackifiers can increase the adhesion of the pressure sensitive adhesive, making it aggressively adhere to wide range of substrates, especially substrates having low surface energy, such as polyethylene and polypropylene. However, hydrocarbon tackifying resins, especially when used at levels needed to obtain such high tack, may detrimentally affect the shear and cohesive strength of a pressure sensitive adhesive, and can raise the T_{g} of the adhesive. The use of high levels of hydrocarbon tackifying resin can be particularly detrimental to hot melt processable pressure sensitive adhesives.

Additionally, thermally- or photo-initiated free radical (co)polymerization generally leaves in the (co)polymerization product a fraction of the residual initiator and initiator fragments which can cause haze, and which may yellow over time. In contrast, the use of ionizing radiation to initiate (co)polymerization generally does not require the addition of a polymerization initiator, as the ionizing radiation itself initiates (co)polymerization. Thus, (co)polymerization using ionizing radiation produces a cleaner reaction product with less haze and yellowing.

For at least the foregoing reasons, there is a need for a highly tackified ionizing radiation crosslinked pressure sensitive adhesive which overcomes at least some of the deficiencies described above, and which provides high cohesive strength at elevated temperature and high-temperature shear resistance while ensuring excellent adhesion to various types of substrates.

Thus, in one aspect, the present disclosure relates to an ionizing radiation crosslinkable pressure sensitive adhesive precursor having a total acid content of from 0 wt. % to not more than 3 wt. % by weight of the adhesive precursor, the adhesive precursor including a (meth)acrylate base (co)polymer, a hydrocarbon tackifying resin in an amount greater than 40 parts by weight per 100 parts by weight of the (meth)acrylate base (co)polymer, and optionally a (co)polymerized hydrogen-donating monomer. Optionally, the adhesive precursor is substantially free of catalysts, thermal initiators and photoinitiators.

In another aspect, the present disclosure relates to a method of making an ionizing radiation crosslinked pressure sensitive adhesive including providing an adhesive precursor mixture having a total acid content of from 0 wt. % to not more than 3 wt. % by weight of the adhesive precursor mixture, the adhesive precursor mixture including a (meth)acrylate base (co)polymer, a hydrocarbon tackifying resin in an amount greater than 40 parts by weight per 100 parts by weight of the (meth)acrylate base (co)polymer, and optionally a (co)polymerized hydrogen-donating monomer; and exposing the adhesive precursor mixture to a source of ionizing radiation for an exposure time sufficient to achieve an energy dose sufficient to at least partially crosslink the adhesive precursor mixture to form a pressure sensitive adhesive. Optionally, the adhesive precursor is substantially free of catalysts, thermal initiators, and photoinitiators. The source of ionizing radiation may, for example, include one or both of an electron beam and gamma radiation.

In still another aspect, the present disclosure relates to the use of an ionizing radiation crosslinkable pressure sensitive adhesive precursor as described above, to make an adhesive article, such as a single-sided or double-sided adhesive tape, or an adhesive label.

### Listing of Exemplary Embodiments

A. An ionizing radiation crosslinkable pressure sensitive adhesive precursor comprising:
   a (meth)acrylate base (co)polymer;
   a hydrocarbon tackifying resin in an amount greater than 40 parts by weight per 100 parts by weight of the (meth)acrylate base (co)polymer; and optionally
   a (co)polymerized hydrogen-donating monomer,
   wherein the adhesive precursor has a total acid content of from 0 wt. % to not more than 3 wt. % by weight of the adhesive precursor, optionally wherein the adhesive precursor is substantially free of catalysts, thermal initiators and photoinitiators.
B. An adhesive precursor according to Embodiment A, further comprising at least one crosslinkable (co)polymerizable compound capable of crosslinking with at least one component of the adhesive precursor mixture, wherein the at least one crosslinkable (co)polymerizable compound comprises at least one carbon to carbon double bond, optionally wherein the crosslinkable (co)polymerizable compound is a multifunctional (meth)acrylate.
C. An adhesive precursor according to Embodiment B, wherein the at least one crosslinkable (co)polymerizable compound is a multifunctional (meth)acrylate selected from trimethylolpropane tri(meth)acrylate, propoxylated trimethylolpropane triacrylates, ethoxylated trimethylolpropane triacrylates, tris(2-hydroxy ethyl)isocyanurate triacrylate, pentaerythritol triacrylate. ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylate, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, urethane di(meth)acrylates, and combinations thereof.
D. An adhesive precursor according to any preceding Embodiment, wherein the (co)polymerized hydrogen-donating monomer is present as a (co)monomer in a crosslinking (co)polymer that is distinct from the (meth)acrylate base (co)polymer.
E. An adhesive precursor according to any preceding Embodiment, wherein the amount of hydrocarbon tackifying resin is greater than greater than 80 parts weight of (meth)acrylate base (co)polymer.
F. An adhesive precursor according to any preceding Embodiment, wherein the amount of the crosslinkable (co)polymerizable compound is from 0.18 to 0.7 parts by weight per 100 parts by weight of the (meth)acrylate base (co)polymer.
G. An adhesive precursor according to any preceding Embodiment, wherein the (co)polymerized hydrogen-donating monomer is present in an amount from 0.1 to 3 parts by weight per 100 parts by weight of the (meth)acrylate base (co)polymer.
H. An adhesive precursor according to Embodiment G, wherein the (co)polymerized hydrogen-donating monomer is selected from the group consisting of (meth)acrylamide, (meth)acrylate monomers containing at least one nitrogen functional group, urethane (meth)acrylate monomers containing at least one nitrogen functional group, vinylic monomers containing at least one nitrogen functional group, and combinations thereof.
I. An adhesive precursor according to Embodiment H, wherein the (co)polymerized hydrogen-donating monomer is selected from the group consisting of N,N-dimethyl (meth)acrylamide; N,N-diethyl (meth)acrylamide; N-vinyl caprolactam; N-vinylpyrrolidone; N-isopropyl (meth)acrylamide; N,N-dimethylaminoethyl (meth)acrylate; 2-[[(Butylamino)carbonyl]oxy]ethyl (meth) acrylate N,N-dimethylaminopropyl (meth)acrylamide; N,N-diethylaminopropyl (meth)acrylamide; N,N-diethylaminoethyl (meth)acrylate; N,N-dimethylaminopropyl (meth)acrylate; N,N-diethylaminopropyl (meth)acrylate; N,N-dimethylaminoethyl (meth)acrylamide; N,N-diethylaminoethyl (meth)acrylamide; (meth)acryloyl morpholine, vinylacetamide and any combinations or mixtures thereof. Preferably still, the (co)polymerized hydrogen-donating monomer for use herein is selected from the group consisting of N,N-dimethyl acrylamide; N,N-dimethylaminoethyl (meth)acrylate; N,N-diethylaminoethyl (meth)acrylate, vinylacetamide and any combinations or mixtures thereof.
J. An adhesive precursor according to any preceding Embodiment, further comprising a (co)polymerized Norrish type (II) photocrosslinker.
K. An adhesive precursor according to Embodiment J, wherein the (co)polymerized Norrish type (II) photocrosslinker is present as a (co)monomer in a crosslinking (co)polymer that is distinct from the (meth)acrylate base (co)polymer.
L. An adhesive comprising a crosslinked form of the adhesive precursor of any preceding Embodiment.
M. An article comprising the adhesive precursor of any one of Embodiments A-K, or the adhesive of Embodiment L.
N. The article of Embodiment M, further comprising one or more adherends.
O. The article of Embodiment N, wherein the article is an adhesive tape.
P. The article of Embodiment N, wherein the article is an adhesive label.
Q. The article of any one of Embodiments M-P, wherein the article further comprises a release liner.
R. A method of making a crosslinked adhesive, comprising:
   providing an adhesive precursor mixture further comprising:
      a (meth)acrylate base (co)polymer;
      a hydrocarbon tackifying resin, in an amount greater than 40 parts by weight per 100 parts by weight of the (meth)acrylate base (co)polymer; and optionally
      a (co)polymerized hydrogen-donating monomer,
      wherein the adhesive precursor mixture has a total acid content of from 0 wt. % to not more than 3 wt. % by weight of the adhesive precursor, optionally wherein the adhesive precursor mixture is substantially free of catalysts, thermal initiators and photoinitiators; and
   exposing the adhesive precursor mixture to a source of ionizing radiation for an exposure time sufficient to achieve an energy dose sufficient to at least partially crosslink the adhesive precursor mixture to form a pressure sensitive adhesive, optionally wherein the source of ionizing radiation is selected from an electron beam, a source of gamma radiation, or a combination thereof.
S. The method according Embodiment R, wherein the adhesive precursor mixture further comprises at least one crosslinkable (co)polymerizable compound capable of crosslinking with at least one component of the adhesive precursor mixture, wherein the at least one crosslinkable (co)polymerizable compound comprises at least one carbon to carbon double bond, optionally wherein the crosslinkable (co)polymerizable compound is a multifunctional (meth)acrylate.
T. The method according to Embodiment S, wherein the at least one crosslinkable (co)polymerizable compound is a multifunctional (meth)acrylate selected from trimethylolpropane tri(meth)acrylate, propoxylated trimethylolpropane triacrylates, ethoxylated trimethylolpropane triacrylates, tris(2-hydroxy ethyl)isocyanurate triacrylate, pentaerythritol triacrylate. ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylate, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, urethane di(meth)acrylates, and combinations thereof.
U. The method of Embodiments R-T, wherein the ionizing radiation energy dose is at least 50 kGy, optionally wherein the ionizing radiation energy dose is no more than 500 kGy.
V. The method of Embodiments R-U, wherein the ionizing radiation exposure time (i.e., dose) is at least 1 second, optionally wherein the ionizing radiation exposure time is no more than 120 seconds.

Various unexpected results and advantages may be obtained in exemplary embodiments of the disclosure. Unexpectedly, exemplary embodiments of the foregoing combinations of elements in the specified amounts and having the specified acid content in an adhesive precursor, provide, after a suitable ionizing radiation induced crosslinking step, highly tackified pressure sensitive adhesives having beneficial properties. Such beneficial properties can include, for example, one or more of good shear properties, particularly on low energy surfaces, and good hot melt processability.

One advantage associated with some embodiments using a source of ionizing radiation to effect (co)polymerization or crosslinking of a PSA precursor includes the potential to produce clean and clear (co)polymer pressure sensitive adhesives suitable for use in electronic, medical, passenger vehicle interior, and optical applications. Use of ionizing radiation during the (co)polymerization or crosslinking process tends to graft lower molecular weight species to larger polymer networks, reducing residual levels of undesirable extractable materials, such as residual monomers, and other undesirable by-products. (Co)polymers produced with low extractables and no initiators (or their fragments) can be particularly useful in applications where these residuals and by-products are undesirable, such as in skin-contacting medical tapes or low volatile organic compound (VOC) adhesives for use in passenger vehicle (e.g. aircraft, trains, automobiles and boats) interiors.

Furthermore, the absence of catalysts and photoinitiators in ionizing radiation crosslinked PSAs makes the optical activity (absorbance of light) of the final PSA substantially identical to that of the mixture of ethylenically-unsaturated material used as the starting point in the (co)polymerization process, and thus the resulting PSA (co)polymers may be optically inert and/or optically clear. Thus in some embodiments, the ionizing radiation crosslinked adhesive precursors of the present disclosure may be useful as optically clear adhesives.

Additionally, use of ionizing radiation to initiate (co)polymerization can desirably yield crosslinked (co)polymers which are highly branched and/or highly crosslinked, and are thus particularly well-suited for pressure sensitive adhesive applications. Thus, use of ionizing radiation to effect crosslinking may produce an adhesive, more particularly a pressure sensitive adhesive, even more particularly a hot melt pressure sensitive adhesive, containing low or no volatile organic compounds (VOC), low or reduced FOG (volatile organic compound emissions determined according to VDA-278), exhibiting decreased odor, and having improved shelf stability.

Other advantages of the adhesive precursors, crosslinked pressure sensitive adhesives, adhesive articles, and methods of the present disclosure will be apparent from the following detailed description.

Various aspects and advantages of exemplary embodiments of the disclosure have been summarized. The above Summary is not intended to describe each illustrated embodiment or every implementation of the present certain exemplary embodiments of the present disclosure.

### DETAILED DESCRIPTION

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation.

As used in this specification and the appended embodiments, the singular forms “a”, “an”, and “the” include plural referents unless the content clearly dictates otherwise. Thus, for example, reference to “a compound” includes a mixture of two or more compounds.

The terms “about” or “approximately” with reference to a numerical value or a shape means +/−five percent of the numerical value or property or characteristic, but expressly includes the exact numerical value. For example, a viscosity of “about” 1 Pa-sec refers to a viscosity from 0.95 to 1.05 Pa-sec, but also expressly includes a viscosity of exactly 1 Pa-sec. Similarly, a perimeter that is “substantially square” is intended to describe a geometric shape having four lateral edges in which each lateral edge has a length which is from 95% to 105% of the length of any other lateral edge, but which also includes a geometric shape in which each lateral edge has exactly the same length.

The term “or” is generally employed in its sense including “and/or” unless the content clearly dictates otherwise.

The term “adhesive” as used herein refers to polymeric compositions useful to adhere together two adherends. Examples of adhesives are pressure sensitive adhesives.

The term “acid content” refers to the total content of polymerized monomers bearing an acid moiety, such as a carboxylic acid, a sulphonic acid or phosphonic acid moiety. Unless otherwise noted, acid content is described herein as a weight percent. The “total acid content” of multiple items refers to the weight percent of polymerized monomers bearing an acid moiety, such as those described above, of all of the enumerated items.

The term “alkyl” refers to a monovalent group that is a radical of an alkane, which is an aliphatic hydrocarbon. The alkyl can be linear, branched, cyclic, or combinations thereof and typically has 1 to 24 carbon atoms. In some embodiments, the alkyl group contains 1 to 18, 1 to 12, 1 to 10, 1 to 8, 1 to 6, or 1 to 4 carbon atoms.

The term “crosslinked (co)polymer” refers to a (co)polymer whose molecular chains are joined together by covalent chemical bonds, usually via crosslinking molecules or groups, to form a network (co)polymer. A crosslinked (co)polymer is generally characterized by insolubility, but may be swellable in the presence of an appropriate solvent.

The term “crosslinker” is synonymous with the term “crosslinkable (co)polymerizable compound,” which upon electron beam or gamma irradiation, becomes excited to a higher energy state to form a radical, often a multi-functional radical, which can undergo crosslinking. In some cases, radicals may be formed by abstracting a hydrogen atom from a (meth)acrylate base (co)polymer engaging in free radical polymerization, or alternatively, a hydrogen-donating molecule engaging in a Norrish type II reaction thereby generating a free radical capable of further reaction, such as e.g. free radical addition polymerization, free radical addition crosslinking, and the like.

The terms “(co)polymer” or “(co)polymers” includes homopolymers and copolymers, as well as homopolymers or copolymers that may be formed in a miscible blend, e.g., by coextrusion or by reaction, including, e.g., transesterification. The term “copolymer” includes random, block and star (e.g. dendritic) copolymers.

The expression “(co)polymerized crosslinker” refers to a crosslinker that is present as a (co)monomer in at least one (co)polymer. The at least one (co)polymer can be a (meth)acrylate base (co)polymer, a crosslinking (co)polymer, or both.

The term “hydrogen-donating monomer” refers to a monomer containing at least one hydrogen atom that is abstractable by an excited state crosslinker. The expression “(co)polymerized hydrogen-donating monomer” is refers to a hydrogen-donating monomer that is present as a (co)monomer in at least one (co)polymer. The at least one (co)polymer can be an (meth)acrylate base (co)polymer, a crosslinking (co)polymer, or both.

The term “(meth)acrylate” refers to both “acrylate” and “methacrylate” monomers, oligomers or polymers that are derived from monomeric acrylic or methacrylic acids or their esters. Thus, acrylate and methacrylate monomers, oligomers, or polymers are referred to collectively herein as “(meth)acrylates”.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g. visible light) than it fails to transmit (e.g. absorbs and reflects). Thus, a substrate that transmits more than 50% of the visible light incident upon its surface is substantially transparent, but a substrate that transmits 50% or less of the visible light incident upon its surface is not substantially transparent.

The term “type (II) photocrosslinker” refers to a photocrosslinker, which upon irradiation, becomes excited to a higher energy state in which it can abstract a hydrogen atom from a hydrogen-donating molecule, typically in a process such as a Norrish type II reaction, thereby generating on the hydrogen-donating molecule a free radical capable of further reaction, such as e.g. free radical addition polymerization, free radical addition crosslinking. The expression “(co)polymerized type (II) photocrosslinker” refers to a type (II) photocrosslinker that is present as a (co)monomer in at least one (co)polymer distinct from the (meth)acrylate base polymer, for example, a distinct crosslinking (co)polymer.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Exemplary embodiments of the present disclosure may take on various modifications and alterations without departing from the spirit and scope of the present disclosure. The exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the limitations set forth in the claims and any equivalents thereof. Various exemplary embodiments of the disclosure will now be described.

The present disclosure provides a highly tackified electron beam and/or gamma radiation crosslinked pressure sensitive adhesive which is, in particular, provided with high cohesive strength at elevated temperature whilst ensuring excellent adhesion to various types of substrates, in particular low surface energy (LSE) substrates, such as polyethylene and polypropylene. In particular, the present disclosure provides versatile highly tackified radiation crosslinkable PSA formulations, in particular solventless acrylate PSA formulations.

### Electron Beam or Gamma Radiation Crosslinkable Precursor

In exemplary embodiments of the present disclosure, an ionizing radiation crosslinkable pressure sensitive adhesive precursor is provided having a total acid content of from 0 wt. % to not more than 3 wt. % by weight of the adhesive precursor. The adhesive precursor includes a (meth)acrylate base (co)polymer, and a hydrocarbon tackifying resin in an amount greater than 40 parts by weight per 100 parts by weight of the (meth)acrylate base (co)polymer. In some exemplary embodiments, the adhesive precursor is substantially free or entirely free of catalysts and photoinitiators. In certain such exemplary embodiments, an ionizing radiation crosslinkable (co)polymerizable compound (i.e., a crosslinker) including at least one carbon to carbon double bond may be included in the ionizing radiation crosslinkable adhesive precursor. In some such exemplary embodiments, the adhesive precursor further includes an optional (co)polymerized hydrogen-donating monomer.

When acidic monomers, such as those containing, for example, a carboxylic acid, sulphonic acid, phosphoric acid, or similar acid functional group are present, they are present such that the total acid content of the adhesive precursor, including the (meth)acrylate base (co)polymer, the hydrocarbon tackifying resin, any optional ionizing radiation crosslinkable (co)polymerizable compound, and any optional (co)polymerized hydrogen donating monomer, is no more than 3% by weight (wt. %), sometimes no more than 2 wt. %, no more than 1.5 wt. %, no more than 1.0 wt. % or no more than 0.5 wt. %; in some cases, the acid content of these three components is 0 wt. %.

### (Meth)Acrylate Base (Co)Polymer

The e-beam or gamma radiation crosslinkable pressure sensitive adhesive precursor includes a (meth)acrylate base (co)polymer. Any suitable (meth)acrylate base (co)polymer can be used.

Preferably, the (meth)acrylate base (co)polymer contains a polymerized form of least one linear or branched alkyl (meth)acrylate monomer, wherein the linear or branched alkyl group of the alkyl (meth)acrylate monomer preferably comprises from 1 to 24, more preferably from 4 to 20, even more preferably 6 to 18, still more preferably from 8 to 12 carbon atoms. The (meth)acrylate base (co)polymer can be prepared by polymerizing a mixture of the above-mentioned monomers by any suitable method; suitable methods are known in the art. The mixture has an acid content of no more than 3%, in order to provide an (meth)acrylate base (co)polymer with an acid content of no more than 3%. Typically, acid content is no more than 2%, no more than 1.5%, no more than 1%, or no more than 0.5%. In one particular aspect, the (meth)acrylate base (co)polymer for use various embodiments of the present disclosure is free of acrylic acid, methacrylic acid, and any other monomers bearing an acid moiety.

In a preferred aspect, at least one linear or branched alkyl (meth)acrylate monomer is selected from the group consisting of methyl acrylate, ethyl acrylate, propyl acrylate, such as n-propyl acrylate and isopropyl acrylate, butyl acrylate, such as n-butyl acrylate and isobutyl acrylate, pentyl acrylate, such as n-pentyl and iso-pentyl acrylate, hexyl acrylate, such as n-hexyl acrylate and iso-hexyl acrylate, octyl acrylate, such as iso-octyl acrylate and 2-ethylhexyl acrylate, nonyl acrylate, decyl acrylate, such as 2-propylheptyl acrylate, dodecyl acrylate, lauryl acrylate, octadecyl acrylate, such as C18 acrylate derived from Guerbet alcohols, which can be 2-hetpyl undecanyl acrylate, and any combinations or mixtures thereof.

More preferably, the at least one alkyl (meth)acrylate monomer for use herein is selected from the group consisting of iso-octyl acrylate, 2-ethylhexyl acrylate, decyl acrylate such as 2-propylheptyl acrylate, octadecyl acrylate, such as stearyl acrylate and C18 acrylate derived from Guerbet alcohols, such as 2-hetpyl undecanyl acrylate, and any combinations or mixtures thereof. Still more preferably, the alkyl (meth)acrylate monomer for use herein comprises iso-octyl acrylate.

Typically, the (meth)acrylate base (co)polymer for use in the present disclosure is prepared from a monomer mixture comprising from 50 to 100 parts, from 70 to 100 parts, from 80 to 100 parts, or even from 90 to 100 parts by weight of at least one linear or branched alkyl (meth)acrylate monomer, wherein the linear or branched alkyl group of the alkyl (meth)acrylate monomer preferably comprises from 1 to 24, more preferably from 4 to 20, even more preferably 6 to 18, still more preferably from 8 to 12 carbon atoms.

Optionally, one or more of acrylic acid, methacrylic acid or any other monomers bearing an acid moiety can be included in the (meth)acrylate base (co)polymer as well, however, the combined weight of the acrylic acid, methacrylic acid, and any other monomers bearing an acid moiety is no more than 3% by weight, such as no more than 2%, no more than 1.5%, no more than 1%, or no more than 0.5%, based on the total weight of the (meth)acrylate base (co)polymer. In one particular embodiment the (meth)acrylate base (co)polymer is free of monomers bearing an acid moiety.

Optionally, one or more monoethylenically unsaturated (co)monomers may be present in the (pre-polymerization) monomer mixture used to prepare the (meth)acrylate base (co)polymer, in an amount of from 0.5 to 50 parts (co)monomer, and are thus typically polymerized with the (meth)acrylate monomers. Examples of suitable (co)monomers include cyclohexyl (meth)acrylate, (meth)acrylonitrile, vinyl acetate, isobornyl (meth)acrylate, hydroxyalkyl (meth)acrylates, (meth)acrylamide, vinyl esters of neodecanoic, neononanoic, neopentanoic, 2-ethylhexanoic, or propionic acids (e.g., available from Union Carbide Corp. (Danbury, Conn.) under the designation “Vynates”), vinylidene chloride, alkyl vinyl ethers, ethoxyethoxy ethyl acrylate and methoxypolyethylene glycol 400 acrylate (available from Shin Nakamura Chemical Co., Ltd. under the designation “NK Ester AM-90G”) and any combinations or mixtures thereof.

When present, the monoethylenically unsaturated (co)monomer is typically used in amounts ranging from 0.5 to 25, from 1.0 to 15, from 1.0 to 8.0, from 2.0 to 6.0, or even from 3.0 to 5.0 parts, by weight per 100 parts by weight of (meth)acrylate base (co)polymer.

Preferably, the (meth)acrylate base (co)polymer comprises at least one (meth)acrylate monomer, even more preferably an alkyl (meth)acrylate monomer. Thus, the pre-polymerization mixture used to prepare the (meth)acrylate base (co)polymer also preferably contains at least one (meth)acrylate monomer, even more preferably an alkyl (meth)acrylate monomer.

Preferably, the (meth)acrylate base (co)polymer comprises a (co)polymer of iso-octyl acrylate, 2-ethylhexyl acrylate, 2-propyl heptyl acrylate or linear or branched octadecyl acrylate. The (meth)acrylate base (co)polymer optionally comprised acrylic acid. In this case, the acrylic acid is present in no more than 3% by weight, such as no more than 2%, no more than 1.5%, no more than 1%, or no more than 0.5%, based on the total weight of the (meth)acrylate base (co)polymer.

The ionizing radiation crosslinkable pressure sensitive adhesive precursor may additionally include a (co)polymerized crosslinker. Suitable (co)polymerized crosslinkers for use herein will be easily identified by those skilled in the art, in the light of the present description.

In some exemplary aspects, the (co)polymerized crosslinker is an ethylenically unsaturated crosslinker including at least one carbon to carbon double bond. Suitable ethylenically unsaturated crosslinkers may be selected from the group consisting of mono-and multi-ethylenically unsaturated aromatic ketone (co)monomers free of ortho-aromatic hydroxyl groups such as those disclosed in U.S. Pat. No. 4,737,559 (Kellen et al.). Specific examples of mono-ethylenically unsaturated aromatic ketone comonomers include the copolymerizable photosensitive crosslinkers para-acryloxybenzophenone (ABP), para-acryloxyethoxy-benzophenone (AEBP), para-N-(methylacryloxyethyl)-carbamoylethoxybenzophenone, 4-acryloyloxydiethoxy-4-chlorobenzophenone, para-acryloxyacetophenone, ortho-acrylamidoacetophenone, acrylated anthraquinones, and any combinations or mixtures thereof.

The (co)polymerized crosslinkers may typically be used in an amount from 0.10 to 1 parts, from 0.11 to 1 parts, from 0.16 to 1 parts, from 0.18 to 0.70 parts, or even from 0.20 to 0.50 parts by weight per 100 parts by weight of (meth)acrylate base (co)polymer (or of pre-polymerization monomer mixture used to prepare the (meth)acrylate base (co)polymer).

In some cases, the (co)polymerized crosslinker can act as a (co)monomer that polymerizes with the (meth)acrylate base (co)polymer. In such cases, it may be (co)polymerized together with the other monomers in the pre-polymerization monomer mixture used to prepare the (meth)acrylate base (co)polymer.

In other cases, the (co)polymerized crosslinker can be present as a (co)monomer in a crosslinking (co)polymer, preferably an (meth)acrylate crosslinking (co)polymer. Such crosslinking (co)polymer is a distinct (co)polymer from the (meth)acrylate base (co)polymer.

In still other cases, the (co)polymerized crosslinker can be present as a (co)monomer in a crosslinking (co)polymer and can also be present as a (co)monomer in the (meth)acrylate base (co)polymer.

The pre-polymerization monomer mixture used to prepare the (meth)acrylate base (co)polymer may be (co)polymerized by thermal polymerization or by a combination of thermal and radiation (actinic and/or ionizing radiation) polymerization. For thermal polymerization, a thermal initiator may be included. Thermal initiators useful in various embodiments of the present disclosure include, but are not limited to azo, peroxide, persulfate, and redox initiators. Azo-type initiators, such as e.g., the “VAZO” azo-type initiators commercially available from WAKO Chemical Co. (Wilmington, Del.), are particularly preferred. The thermal initiator may be used in an amount from about 0.01 to about 5.0 parts by weight per 100 parts by weight of total monomer, preferably from 0.025 to 2 weight percent.

Unexpectedly, this particular combination of elements in the specified amounts and having the specified acid content, results in a precursor that, after a suitable crosslinking step, provides highly tackified pressure sensitive adhesives having beneficial properties. Such beneficial properties can include, for example, one or more of good shear properties, particularly on low energy surfaces, and hot melt processability. In some presently preferred embodiments, the precursor is substantially free of catalysts and photoinitiators, or even entirely free of catalysts and photoinitiators, In certain most preferred embodiments, the crosslinked pressure sensitive adhesive is substantially free of catalysts and photoinitiators, or even entirely free of catalysts and photoinitiators, Other beneficial properties can be present.

### Hydrocarbon Tackifying Resin

The precursor omposition further comprises one or more hydrocarbon tackifying resins. Any suitable hydrocarbon tackifying resin can be used. Suitable hydrocarbon tackifying resins include those selected from the group consisting of terpenes, aliphatic C5 hydrocarbons, aromatic C9 hydrocarbons, their (partially) hydrogenated versions and any combinations thereof. Useful commercially available hydrocarbon tackifying resins include those available under the trade designations ESCOREZ 1102, ESCOREZ 1310, ESCOREZ 2173 and ESCOREZ 2203 (aliphatic/aromatic hydrocarbon resins) commercially available from Exxon-Mobil, Corp. (Houston, Tex.); and those available under the trade designations REGALITE 7100 and REGALITE 9100 (partially hydrogenated hydrocarbon resins) commercially available from Eastman, Corp (Kingsport, Tenn.).

The one or more hydrocarbon tackifying resins are present at levels that provide, upon crosslinking of the precursor, a tackified pressure sensitive adhesive. Typical levels are greater than 40 parts by weight, greater than 50 parts by weight, greater than 60 parts by weight, greater than 70 parts by weight, or greater than 80 parts by weight of the hydrocarbon tackifying resin per 100 parts by weight of (meth)acrylate base (co)polymer. Typical levels are no more than 150 parts by weight, no more than 125 parts by weight, no more than 110 parts by weight, or no more than 100 parts by weight of the hydrocarbon tackifying resin per 100 parts by weight of (meth)acrylate base (co)polymer. The at least one hydrocarbon tackifying resin is preferably present in an amount greater than 40 parts per weight per 100 parts per weight of the acrylate base (co)polymer.

In some particular aspects, the amount of hydrocarbon tackifying resin present in the radiation crosslinkable pressure sensitive adhesive precursor is greater than 45 parts, 50 or greater than 50 parts, 60 or greater than 60 parts or even 80 or greater than 80 or even 100 or greather than 100 parts by weight per 100 parts by weight of (meth)acrylate base (co)polymer. In some other aspects, the radiation crosslinkable pressure sensitive adhesive precursor comprises from 40 to 150 parts, from 60 to 125 parts, from 75 to 125 parts, or even from 80 to 100 parts by weight of hydrocarbon tackifying resin per 100 parts by weight of (meth)acrylate base (co)polymer.

Unexpectedly, these high amounts of hydrocarbon tackifying resin, when used in conjunction with the other elements described herein, form a precursor that, upon crosslinking, provides aggressive tack without any of the disadvantages of such resins.

Preferably the hydrocarbon tackifying resin is selected from the group consisting of terpenes, aliphatic C5 hydrocarbons, aromatic C9 hydrocarbons, their (partially) hydrogenated versions and any combinations thereof.

### Optional Crosslinkable (Co)Polymerizable Compounds

Crosslinking is used in the adhesive compositions and processes of the present disclosure. Thus, in certain exemplary embodiments, an ionizing radiation crosslinkable (co)polymerizable compound (i.e., a crosslinker) including at least one carbon to carbon double bond may be included in the ionizing radiation crosslinkable adhesive precursor. The crosslinkable (co)polymerizable compounds are capable of crosslinking with at least one component of the adhesive precursor mixture, preferably under ionizing radiation exposure. The crosslinkable (co)polymerizable compound(s) preferably include at least one carbon to carbon double bond, that is, the monomer is ethylenically unsaturated. More preferably, the crosslinkable (co)polymerizable compound comprises an ethylenically unsaturated multifunctional (meth)acrylate.

The optional one or more crosslinkable (co)polymerizable compound(s) or crosslinker(s) may be added to the adhesive precursor used in the processes of the present disclosure before, during, or after application to a substrate. Thus, the optional crosslinkable (co)polymerizable compound(s) may be included in the pre-polymerization monomer mixture used to prepare the (meth)acrylate base (co)polymer, typically at low concentration.

The crosslinkable (co)polymerizable compound(s) are preferably ethylenically unsaturated multi-functional monomers, more preferably ethylenically unsaturated multi-functional (meth)acrylic monomers. Examples of such ethylenically unsaturated multifunctional (meth)acrylate monomers include, for example, tri(meth)acrylates and di(meth)acrylates (that is, compounds comprising three or two (meth)acrylate groups, respectively). Typically di(meth)acrylate monomers (that is, compounds comprising two (meth)acrylate groups) are used. Useful di(meth)acrylates include, for example, ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylate, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, and urethane di(meth)acrylates. The branching agent 1,6-hexanediol diacrylate (HDDA) is particularly suitable. Typically the di(meth)acrylate branching agent is used in amounts ranging from 0 to 0.05 parts by weight per 100 parts by weight of (meth)acrylate base (co)polymer.

Useful tri(meth)acrylates include, for example, trimethylolpropane tri(meth)acrylate, propoxylated trimethylolpropane triacrylates, ethoxylated trimethylolpropane triacrylates, tris(2-hydroxy ethyl)isocyanurate triacrylate, and pentaerythritol triacrylate.

Should one or more of the crosslinkable (co)polymerizable compounds contain an acid moiety, the combined weight of the one or more of the crosslinkable (co)polymerizable compounds containing an acid moiety in the adhesive precursor should be no more than 3% by weight, such as no more than 2%, no more than 1.5%, no more than 1%, or no more than 0.5%, based on the total weight of the precursor.

### Optional Distinct Crosslinkable (Co)Polymer

In some cases, the ionizing radiation crosslinkable adhesive precursor comprises a crosslinkable (co)polymer distinct from the (meth)acrylate base (co)polymer. Suitable compositions for forming a crosslinkable (co)polymer for use herein will be easily identified by those skilled in the art, in the light of the present disclosure. Exemplary compositions useful for preparing a crosslinkable (co)polymer for use herein include, but are not limited to, those comprising a monomer mixture comprising monomers selected from the group consisting of (meth)acrylic monomers, vinyl ester monomers, and any combinations or mixtures thereof. Accordingly, crosslinkable (co)polymers for use herein may be (meth)acrylate, vinyl ester, and any combinations or mixtures thereof.

In a preferred aspect, the crosslinking (co)polymer is a (meth)acrylate crosslinkable (co)polymer. (Meth)acrylate monomers useful for forming the (meth)acrylate crosslinkable (co)polymer for use herein may be identical or distinct from the compositions used for forming the (meth)acrylate base (co)polymer, as described herein above.

In a preferred aspect, the (meth)acrylate crosslinkable (co)polymer for use in various embodiments of the present disclosure, is prepared from a monomer mixture comprising at least one linear or branched alkyl (meth)acrylate monomer, wherein the linear or branched alkyl group of the alkyl (meth)acrylate monomer preferably comprises from 1 to 24, more preferably from 4 to 20, even more preferably 6 to 18, still more preferably from 8 to 12 carbon atoms.

In a preferred aspect, at least one linear or branched alkyl (meth)acrylate monomer is selected from the group consisting of methyl acrylate, ethyl acrylate, propyl acrylate, such as n-propyl acrylate and isopropyl acrylate, butyl acrylate, such as n-butyl acrylate and isobutyl acrylate, pentyl acrylate, such as n-pentyl and iso-pentyl acrylate, hexyl acrylate, such as n-hexyl acrylate and iso-hexyl acrylate, octyl acrylate, such as iso-octyl acrylate and 2-ethylhexyl acrylate, nonyl acrylate, decyl acrylate, such as 2-propylheptyl acrylate, dodecyl acrylate, lauryl acrylate, octadecyl acrylate, such as stearyl acrylate and C18 acrylate derived from Guerbet alcohols and any combinations or mixtures thereof.

More preferably, the alkyl (meth)acrylate monomer for use herein is selected from the group consisting of iso-octyl acrylate, 2-ethylhexyl acrylate, and any combinations or mixtures thereof. Still more preferably, the alkyl (meth)acrylate monomer for use herein comprises (or consists of) iso-octyl acrylate.

In many cases, one or more of the (co)polymerized crosslinkers and the (co)polymerized hydrogen donating monomer are present as (co)monomers in the crosslinking (co)polymer

Suitable (co)polymerized crosslinkers for use herein are as defined further below with respect to the (meth)acrylate base (co)polymer.

Suitable (co)polymerized hydrogen-donating monomer for use herein are as defined above for the (meth)acrylate base (co)polymer and include monomers selected from the group consisting of N,N-dimethyl (meth)acrylamide; N,N-diethyl (meth)acrylamide; N-vinyl caprolactam; N-Vinylpyrrolidone; N-isopropyl (meth)acrylamide; N,N-dimethylaminoethyl (meth)acrylate; 2-[[(Butylamino)carbonyl]oxy]ethyl (meth)acrylate N,N-dimethylaminopropyl (meth)acrylamide; N,N-diethylaminopropyl (meth)acrylamide; N,N-diethylaminoethyl (meth)acrylate; N,N-dimethylaminopropyl (meth)acrylate; N,N-diethylaminopropyl (meth)acrylate; N,N-dimethylaminoethyl (meth)acrylamide; N,N-diethylaminoethyl (meth)acrylamide; (meth)acryloyl morpholine, vinylacetamide and any combinations or mixtures thereof. Preferably still, the (co)polymerized hydrogen-donating monomer for use herein is selected from the group consisting of N,N-dimethyl acrylamide; N,N-dimethylaminoethyl (meth)acrylate; N,N-diethylaminoethyl (meth)acrylate, N,N-dimethylaminopropyl (meth)acrylate, and any combinations or mixtures thereof.

The precursor composition can comprise from 0.5 to 30 parts, from 0.5 to 20 parts, from 1.0 to 10 parts, or even from 2.0 to 8.0 parts by weight per 100 parts by weight of (meth)acrylate base (co)polymer, of the crosslinking (co)polymer, preferably the (meth)acrylate crosslinking (co)polymer.

Optional (co)Polymerized Type (II) Photocrosslinker

In some exemplary embodiments, the ionizing radiation crosslinkable pressure sensitive adhesive precursor may include a (co)polymerized type (II) photocrosslinker. Suitable (co)polymerized type (II) photocrosslinkers for use herein will be easily identified by those skilled in the art, in the light of the present description.

Thus, in some exemplary aspects, the (co)polymerized type (II) photocrosslinkers for use in the present invention are selected from the group consisting of mono-and multi-ethylenically unsaturated aromatic ketone (co)monomers free of ortho-aromatic hydroxyl groups such as those disclosed in U.S. Pat. No. 4,737,559 (Kellen et al.). Specific examples of mono-ethylenically unsaturated aromatic ketone comonomers include the copolymerizable photosensitive crosslinkers para-acryloxybenzophenone (ABP), para-acryloxyethoxybenzophenone (AEBP), para-N-(methylacryloxyethyl)-carbamoylethoxybenzophenone, 4-acryloyloxydiethoxy-4-chlorobenzophenone, para-acryloxyacetophenone, ortho-acrylamidoacetophenone, acrylated anthraquinones, and any combinations or mixtures thereof.

In certain such exemplary embodiments, the (co)polymerized type (II) photocrosslinker for use in the present invention is selected from the group consisting of para-acryloxybenzophenone (ABP), para-acryloxyethoxybenzophenone (AEBP), and any combinations or mixtures thereof.

The (co)polymerized type (II) photocrosslinkers may typically be used in an amount from 0.10 to 1 parts, from 0.11 to 1 parts, from 0.16 to 1 parts, from 0.18 to 0.70 parts, or even from 0.20 to 0.50 parts by weight per 100 parts by weight of acrylate base polymer (or of pre-polymerization monomer mixture used to prepare the acrylate base polymer).

In certain exemplary embodiments, the (co)polymerized type (II) photocrosslinker can be present as a separate (co)monomer in the adhesive precursor. In other exemplary embodiments, the (co)polymerized type (II) photocrosslinker can be present as a (co)monomer in a crosslinkable (co)polymer distinct from the (meth)acrylate base (co)polymer, but nevertheless preferably a (meth)acrylate (co)polymer.

In still other cases, the (co)polymerized type (II) photocrosslinker can be present as a (co)monomer in a crosslinkable (co)polymer distinct from the (meth)acrylate base (co)polymer, and can also be present as a separate (co)monomer in the adhesive precursor.

### Optional Hydrogen-Donating Monomers

Although not presently preferred, the ionizing radiation crosslinkable adhesive precursor composition may, in some exemplary embodiments, optionally further include one or more (co)polymerized hydrogen-donating monomers. Use of an optional hydrogen-donating monomer is preferred when a (co)polymerized type (II) photocrosslinker is included in the adhesive precursor.

Any suitable (co)polymerized hydrogen-donating monomers can be used, provided that the total acid content of the precursor is maintained between 0 wt. % to not more than 3 wt. % by weight of the adhesive precursor.

Exemplary (co)polymerized hydrogen-donating monomers include, but are not limited to, monomers comprising at least one abstractable hydrogen atom typically located on a carbon atom in a position alpha to a nitrogen or an oxygen atom, or carried by terminal or pendant mercapto groups potentially protected during polymerization.

The (co)polymerized hydrogen-donating monomer is often selected from the group consisting of (meth)acrylamide, (meth)acrylate, urethane (meth)acrylate, and vinylic monomers containing at least one nitrogen functional group, preferably a tertiary amine functional group, and any combinations or mixtures thereof.

Examples of suitable (co)polymerized hydrogen-donating monomers include N,N-dimethyl (meth)acrylamide; N,N-diethyl (meth)acrylamide; N-vinyl caprolactam; N-Vinylpyrrolidone; N-isopropyl (meth)acrylamide; N,N-dimethylaminoethyl (meth)acrylate; 2-[(Butylamino)carbonyl]oxy]ethyl (meth)acrylate N,N-dimethylaminopropyl (meth)acrylamide; N,N-diethylaminopropyl (meth)acrylamide; N,N-diethylaminoethyl (meth)acrylate; N,N-dimethylaminopropyl (meth)acrylate; N,N-diethylaminopropyl (meth)acrylate; N,N-dimethylaminoethyl (meth)acrylamide; N,N-diethylaminoethyl (meth)acrylamide; (meth)acryloyl morpholine, vinyl acetamide and any combinations or mixtures thereof. More preferably still, the (co)polymerized hydrogen-donating monomer is selected from the group consisting of N,N-dimethyl acrylamide; N,N-dimethylaminoethyl (meth)acrylate; N,N-diethylaminoethyl (meth)acrylate and any combinations or mixtures thereof.

The (co)polymerized hydrogen-donating monomer is typically used in an amount from 0.05 to 10 parts, from 0.05 to 5 parts, from 0.10 to 3 parts, or even from 0.15 to 2 parts by weight per 100 parts by weight of acrylate base (co)polymer.

In some exemplary embodiments, the (co)polymerized hydrogen-donating monomer is present as a (co)monomer in the (meth)acrylate base (co)polymer. In other cases the (co)polymerized hydrogen-donating monomer is present as a (co)monomer in a (co)polymer that is distinct from the (meth)acrylate base (co)polymer, such as a crosslinking (co)polymer, preferably a (meth)acrylate crosslinking (co)polymer. In still other cases, the (co)polymerized hydrogen-donating monomer is present both as a (co)monomer in the (meth)acrylate base (co)polymer and as a (co)monomer in a (co)polymer that is distinct from the (meth)acrylate base (co)polymer, such as a crosslinking (co)polymer, preferably an (meth)acrylate crosslinking (co)polymer. The (co)polymerized hydrogen-donating monomer can also be (co)polymerized with the (meth)acrylate base (co)polymer.

In other exemplary embodiments, the (co)polymerized hydrogen-donating monomer is (co)polymerized with an optional crosslinker to form a (co)polymer that is distinct from the (meth)acrylate base (co)polymer. In such cases, an additional (meth)acrylate (co)polymer distinct from the (meth)acrylate base (co)polymer can be (co)polymerized with the (co)polymerized crosslinker and any optional (co)polymerized hydrogen-donating monomer.

In further exemplary embodiments, the (co)polymerized hydrogen-donating monomer is (co)polymerized with both the (meth)acrylate base (co)polymer and any (co)polymerized crosslinker such that the polymerized hydrogen-donating monomer is a component of both the (meth)acrylate base (co)polymer and a distinct (co)polymer that also includes the optional (co)polymerized hydrogen-donating monomer. In such cases, any additional (meth)acrylate (co)polymer can also be (co)polymerized with any optional crosslinkable (co)polymerizable compound, any optional crosslinker incorporated into a distinct (co)polymer added to the adhesive precursor, and any optional (co)polymerized hydrogen-donating monomer.

### Optional Adhesive Precursor Additives

As will be apparent to those skilled in the art, the ionizing radiation crosslinkable pressure sensitive adhesive precursor mixture according to the present disclosure may further include a variety of additional additives depending on the envisaged properties for the resulting crosslinked pressure sensitive adhesive. Exemplary additional additives include, but are not limited to, one or more plasticizers, UV stabilizers, antistatic agents, colorants, antioxidants, fungicides, bactericides, organic and/or inorganic filler particles, pigments, and any combinations thereof. In some exemplary embodiments, the additives are non-polymerizable additives. As will be apparent to those skilled in the art, additives may be included in either the adhesive precursor or the crosslinked PSA, and at any appropriate time in the process.

Optional Thermal Initiator(s) and Photoinitiator(s)

Although it is not presently preferred, in some exemplary embodiments, the pre-polymerization monomer mixture used to prepare the (meth)acrylate base (co)polymer sometimes includes an appropriate polymerization initiator, which may be a thermal initiator for inducing free radical polymerization, or a photoinitiator for UV radiation induced polymerization.

For thermal polymerization, a thermal initiator may be included. Thermal initiators are preferred in certain embodiments, as the initiator is largely consumed in the free radical polymerization process, so the resulting adhesive precursor will be substantially free of initiator upon completion of the polymerization to form the (meth)acrylate base (co)polymer. The thermal initiator may be added prior to or during polymerization to form the (meth)acrylate base (co)polymer. Alternatively, but not preferably, a thermal initiator can be added to the adhesive precursor just before crosslinking of the adhesive precursor takes place.

Thermal initiators useful in various embodiments of the present disclosure include, but are not limited to azo, peroxide, persulfate, and redox initiators. Azo-type initiators, such as e.g. the “VAZO” line, commercially available from WAKO Chemical Co (Wilmington, Del.) are particularly preferred.

The optional thermal initiator may be used in an amount from about 0.01 to about 5.0 parts by weight per 100 parts by weight of total monomer, preferably from 0.025 to 2 weight percent.

For polymerization induced by ultraviolet radiation, a photoinitiator may be included. Useful photoinitiators include substituted acetophenones such as benzyl dimethyl ketal and 1-hydroxycyclohexyl phenyl ketone, substituted alpha-ketols such as 2-methyl-2-hydroxypropiophenone, benzoin ethers such as benzoin methyl ether, benzoin isopropyl ether, substituted benzoin ethers such as anisoin methyl ether, aromatic sulfonyl chlorides, photoactive oximes and azo-type initiators.

The optional photoinitiator may be used in an amount from about 0.001 to about 5.0 parts by weight per 100 parts of total monomer, from about 0.01 to about 5.0 parts by weight per 100 parts by weight of total monomer, or even from 0.1 to 0.5 parts by weight per 100 parts by weight of total monomer.

However, in contrast to most previous methods for curing functional materials, the crosslinking methods of the present disclosure do not require the use of added catalysts or initiators (e.g. photoinitiators). Thus, advantageously, in some exemplary embodiments, the methods of the present disclosure do not require the use of an added catalyst or photoinitiator. In other words, exemplary methods of the present disclosure can be used to cure compositions that are “substantially free” of such catalysts or initiators (e.g., photoinitiators).

As used herein, a composition is “substantially free of added catalysts and initiators” if the composition does not include an “effective amount” of an added catalyst or initiator. As is well understood, an “effective amount” of a catalyst or initiator depends on a variety of factors including the type of catalyst or initiator, the composition of the curable material, and the curing method (e.g., thermal cure, UV-cure, and the like). In some embodiments, a particular catalyst or initiator is not present at an “effective amount” if the amount of catalyst or initiator does not reduce the cure time of the composition by at least 10% relative to the cure time for the same composition at the same curing conditions absent that catalyst or initiator.

As stated above, the use of added photoinitiators in the crosslinking of (meth)acrylate-functional (co)polymers introduces added costs and undesirable residuals and byproducts to the process. Articles bearing pressure sensitive adhesives prepared using the preferred catalyst and photoinitiator-free methods of the present disclosure are of particular significance in medical applications, where photoinitiator-induced contamination of pressure sensitive adhesives can lead to skin irritation and other undesirable reactions. Exclusion of this component can result in significant direct cost savings, plus elimination of any expenses involved in commercializing products containing significant amounts of a catalyst or photoinitiator.

Optional Chain Transfer Agent(s)

The ionizing radiation crosslinkable pressure sensitive adhesive precursor mixture can further include, as an optional ingredient, a chain transfer agent to control the molecular weight of the (co)polymer. Chain transfer agents are materials which regulate free radical polymerization and are generally known in the art. The term “chain transfer agent” as used herein also includes “telogens.”

Advantageously, the chain transfer agent may be included in the (pre-polymerization) monomer mixture used to prepare the (meth)acrylate base (co)polymer and/or any crosslinking (co)polymer. Chain transfer agents, which are well known in the (co)polymerization art, may also be included in any of the processes of the present disclosure, for example, to control the molecular weight or other (co)polymer properties.

Suitable chain transfer agents for use in exemplary methods of the present disclosure include but are not limited to those selected from the group consisting of sulfur compounds such as lauryl mercaptan, butyl mercaptan, ethanethiol, isooctylthioglycolate (IOTG), 2-ethylhexyl thioglycolate, 2-ethylhexyl mercaptopropionate, pentaerythritol terakis(3-mercaptopropionate), 2-mercaptoimidazole, 2-mercaptoethanol, 3-mercapto-1,2-propanediol, 2-butyl mercaptan, n-octyl mercaptan, t-dodecylmercaptan, 2-ethylhexyl mercaptopropionate, 2-mercaptoimidazole, 2-mercaptoethyl ether, and 2-mercaptoethyl etherhexanebromoethane; halogenated hydrocarbons such as such as carbon tetrabromide, bromotrichloro-methane; and solvents such as cumene, ethyl acetate, ethanol, 2-propanol; as well as combinations thereof.

Depending on the reactivity of a particular chain transfer agent and the amount of chain transfer desired, typically from 0.01% to 25% by weight of chain transfer agent is used, based upon the total weight of ethylenically-unsaturated (co)polymerizable material used in the mixture. More preferably, from about 0.025 wt. % to about 20.0 wt. % of chain transfer agent is used, based upon the total weight of ethylenically-unsaturated (co)polymerizable material used in the mixture. Most preferably, from about 0.04 wt. % to about 15 wt. % of chain transfer agent is used, based upon the total weight of ethylenically-unsaturated (co)polymerizable material used in the mixture.

### Method of Producing the Crosslinkable PSA Precursor

The ionizing radiation crosslinkable pressure sensitive adhesive precursor according to the present disclosure may be produced using techniques commonly known to those skilled in the art of formulating pressure sensitive adhesive formulations. The polymeric precursor may be obtained in a conventional manner, using e.g., solution, bulk, or emulsion polymerization techniques. The acrylate base (co)polymer may advantageously be obtained using bulk or solution polymerization using thermal or UV techniques. The crosslinking (co)polymer may advantageously be obtained using solution polymerization, followed by stripping of the solvent thereby forming a (co)polymer melt.

Depending on whether the optional crosslinkable (co)polymerizable compound and/or the optional hydrogen-donating monomer are (co)polymerized with the (meth)acrylate base (co)polymer and/or with the crosslinking (co)polymer, the various pre-polymerizations formulations and the corresponding monomer mixtures will be easily apparent to those skilled in the art in the light of the present description.

In some exemplary embodiments, the polymerization steps for the (meth)acrylate base (co)polymer may be effected by exposure to ultraviolet (UV) radiation as described in U.S. Pat. No. 4,181,752 (Martens et al.). In some exemplary embodiments, the polymerization is carried out with UV lights having over 60 percent, or over 75 percent of their emission spectra between 280 to 400 nanometers (nm), with an intensity between about 0.1 to about 25 mW/cm2.

The weight average molecular weight of the (meth)acrylate base (co)polymer and/or any crosslinking (co)polymer having a (co)polymerized crosslinker may advantageously range from about 50,000 to about 3,000,000, or from about 100,000 to about 1,800,000, and more typically from about 200,000 to about 1,500,000.

### Methods of Preparing Pressure Sensitive Adhesives

According to another aspect, the present disclosure relates to a method of making an ionizing radiation crosslinked pressure sensitive adhesive including providing an adhesive precursor mixture having a total acid content of from 0 wt. % to not more than 3 wt. % by weight of the adhesive precursor mixture, the adhesive precursor mixture including a (meth)acrylate base (co)polymer, a hydrocarbon tackifying resin in an amount greater than 40 parts by weight per 100 parts by weight of the (meth)acrylate base (co)polymer, and optionally a (co)polymerized hydrogen-donating monomer; and exposing the adhesive precursor mixture to a source of ionizing radiation for an exposure time sufficient to achieve an energy dose sufficient to at least partially crosslink the adhesive precursor mixture to form a pressure sensitive adhesive. Optionally, the adhesive precursor is substantially free of catalysts, thermal initiators, and photoinitiators. The source of ionizing radiation may, for example, include one or both of an electron beam and/or gamma radiation.

### Ionizing Radiation Crosslinking

In exemplary embodiments, the precursor may be at least partially cured or at least partially crosslinked through exposure to a source of ionizing radiation, for example, one or both of an e-beam or gamma irradiation. Thus, in some embodiments, a combination of electron beam (e-beam) curing and gamma ray curing may be used. For example, in some embodiments, the precursor may be partially cured by exposure to electron beam irradiation. Subsequently, the coating may be further cured by gamma irradiation.

In exemplary embodiments of the present disclosure, a source of ionizing radiation is used to initiate crosslinking of the PSA precursor. Any conventional source of penetrating ionizing radiation may be employed, i.e., any source of low LET (linear energy transfer) radiation which is capable of extracting protons from the monomers to create free radicals which propagate to form (co)polymer chains. The known types of ionizing radiation include, for example, electron beams, gamma rays and X-rays. Thus, the source of ionizing radiation may be a gamma ray source, an x-ray source, an electron beam source, more preferably an electron beam source with an emission energy greater than 300 keV, and combinations thereof.

Generally, a support film or substrate (e.g., polyester terephthalate support film) runs through a chamber with a window exposed to the source of ionizing radiation. The adhesive precursor is applied to a major surface of the support film or support, and crosslinking is initated by exposure to the source of ionizing radiation before, during, or subsequent to application of the adhesive precursor to the major surface. The adhesive precursor may be applied to the support film or substrate using any suitable means, for example, coating from a solvent, coating from a melt, extrusion, and the like. Preferably, the support film is a web fed from one roller and wound onto another roller in a “roll-to-roll” process.

In some exemplary embodiments, a sample of uncured material with a liner (e.g., a silicone or fluorosilicone release liner) on both sides (“closed face”) may be attached to the support film and conveyed at a fixed speed of about 6.1 meters/min (20 feet/min). In some embodiments, a sample of the uncured material may be applied to one liner, with no liner on the opposite surface (“open face”). Generally, the chamber is inerted (e.g., the oxygen-containing room air is replaced with an inert gas, e.g., nitrogen) while the samples are e-beam or gamma radiation cured, particularly when open-face curing.

Electron Beam Radiation Sources

Sources of ionizing radiation such as electron beams (“e-beams”) are known in the art (see e.g., U.S. Pat. Nos. 2,810,933; 5,414,267; 6,038,015; 7,256,139; and 7,348,555). Electron beams are a form of ionizing radiation (as opposed to actinic radiation) that operate by bombarding molecules with electrons. These electrons displace other electrons in the bombarded molecules, thereby creating free radicals, which may react with other molecules. Electron beam radiation produces a high rate of free-radical initiation and may produce free radicals in all components of the system including the product itself as it is being formed (see e.g. Wilson, Radiation Chemistry of Monomers, Polymers, and Plastics, chapter 11, p. 375, New York, 1974). Because of this indiscriminate production of free radicals and high dose rates (radical flux) required to achieve cure, e-beam radiation has generally been used for continuous bulk monomer (as opposed to oligomer or polymer) polymerization processes.

Commercially available electron beam generating equipment may be purchased from a number of sources. One exemplary commercially available electron beam generating apparatus is a Model CB-300 electron beam generating apparatus (available from Energy Sciences, Inc. (Wilmington, Mass.).

In some exemplary embodiments, the electron beam (“e-beam”) is a continuous electron beam. In certain exemplary embodiments, a continuous e-beam may be rapidly scanned. Thus, in one exemplary embodiment, a continuous e-beam is rapidly scanned across the precursor applied to a major surface of a substrate, thereby irradiating the coated surface at a frequency selected to achieve an exposure duration of greater than 0 and no greater than 10 microseconds, and a dark time between each exposure duration of at least one millisecond, thereby producing an at least partially polymerized composition. Observed from a fixed location on the web under the e-beam, rapidly and repeatedly scanning a continuous e-beam focused on a portion of a surface simulates use of a pulsed e-beam source. A brief exposure of a discrete portion of the precursor coated on a major surface of a substrate is followed by dark time while the scanned beam traverses the rest of the scanned area of the coated surface.

Such a focused continuous e-beam exposure overcomes, in some exemplary embodiments, the limitations associated with too low an e-beam dose per pulse, the beam power per unit area increases as the exposed beam area shrinks. By rapidly scanning the continuous focused e-beam over the intended exposure area of the substrate, thereby effectively raising the power-to-area ratio, the desired polymerization rates can be achieved, without excessive average power consumption.

In other exemplary embodiments, the e-beam is a pulsed e-beam. Thus, in one exemplary embodiment, a pulsed e-beam is focused on a precursor coated on a major surface of a substrate and scanned across the surface, thereby irradiating the coated surface at a frequency selected to achieve an exposure duration of greater than 0 and no greater than 10 microseconds, thereby producing an at least partially polymerized composition.

One advantage of scanned, pulsed e-beams is that they do not suffer from the same voltage limitations of regular, linear-filament beams. It is therefore possible to readily scale-up scanned, pulsed e-beam polymerization processes to make use of high powered (i.e. MeV) e-beams, which allow for single-pass irradiation of even very thick (e.g. two or more centimeter thick) substrates.

Gamma Radiation Sources

A source of gamma radiation may be effectively employed as the source of ionizing radiation. Suitable sources of gamma radiation are well known and include, for example, radioisotopes such as cobalt-60 and cesium-137. Generally, suitable gamma ray sources emit gamma rays having energies of 400 keV or greater. Typically, suitable gamma ray sources emit gamma rays having energies in the range of 500 keV to 5 MeV. Examples of suitable gamma ray sources include cobalt-60 isotope (which emits photons with energies of approximately 1.17 and 1.33 MeV in nearly equal proportions) and cesium-137 isotope (which emits photons with energies of approximately 0.662 MeV). The distance from the source can be fixed or made variable by changing the position of the target or the source. The flux of gamma rays emitted from the source generally decays with the square of the distance from the source and duration of time as governed by the half-life of the isotope.

Gamma radiation induces (co)polymerization by directly ionizing the monomer mixture, generating free radicals from which propagation can occur. The depth of penetration and low dose rate of gamma photons are ideal for creating high molecular weight (co)polymers, as initiation occurs throughout the bulk and at a low enough frequency to allow time for long-chain growth. Gamma radiation produces radicals statistically on all species present: difficult-to-polymerize monomers, existing polymer chains, and any other monomers or additives. Thus, incorporation of ethylenically-unsaturated materials with lower reactivity is possible, and short chains can be grafted into a larger polymer network. Ultimately, more highly-branched, multi-functional, lower-residual adhesives can be produced than with chemical initiators.

For ionizing radiation (co)polymerized adhesives, the adhesive properties may be tailored by changing total dose or dose rate (quantity and frequency of free radical generation), rather than relying on compositional changes alone. For example, higher total dose will produce a more crosslinked adhesive, even in the absence of multi-functional monomers. A higher dose rate can generate (co)polymers with higher short-branch content, virtually impossible using standard thermal or photo-initiators.

Although dose can be useful for small adjustments, tailoring (co)polymer properties using dose alone can be a challenge. Target doses must be high enough to ensure nearly complete monomer conversion, but not so high as to fully crosslink the (co)polymer network—typically ∥100 kGy. At low levels of chain transfer agent (CTA), i.e. those typical for traditional UV or thermally-initiated systems, this window is fairly small, e.g., 1 or 2 kGy. One to two kGy precision is not difficult to attain in an experimental capacity, but would pose a large challenge on a manufacturing scale. By incorporating large quantities of CTA (2-6 times traditional levels), a greatly expanded range of acceptable dose is obtained, creating a robust operational process window suitable for a continuous manufacturing process. Highly converted, low gel pressure sensitive adhesives can thus be produced at doses of 50 to 500 kGy.

For typical UV- or thermally-initiated polymerizations, formulations containing high quantities of CTA would produce short-chain adhesives with poor performance. Any short chain produced will persist in the final composition, unless, of course, it goes through another transfer event (unlikely). With gamma (co)polymerization, short chains are not “dead”. Initiation events occur randomly on the short chains and longer ones, and those free-radicals can combine or provide a site for additional monomer incorporation. Thus, through gamma (co)polymerization, we create high molecular weight, branched (co)polymer structures by combining short chains, longer ones, and monomer. These, and other unexpected results and advantages of various processes of the present disclosure are described in detail below.

### Ionizing Radiation Crosslinking Parameters

In a free radical polymerization or crosslinking reaction, the rate of initiation determines the concentration of radicals. The rate of termination is generally proportional to the concentration of radicals, with a comparatively large number of terminations at high radical concentrations. This results in lower molecular weight and highly crosslinked gel. In the present disclosure, the rate of initiation resulting from ionizing radiation may be controlled, so as to achieve high molecular weight between crosslinks and high conversion by decreasing the flux of electrons (current) and increasing the residence time under the beam to accumulate the desired dose. Residence time may be increased by lowering the speed of transit under a scanned e-beam, or by increasing the area of irradiance under the beam.

A variety of procedures for ionizing radiation crosslinking are well-known. The cure or degree of crosslinking depends on the specific equipment used, and those skilled in the art can define a dose calibration model for the specific equipment, geometry, and line speed, as well as other well understood process parameters. In particular, the ionizing radiation exposure time or duration, which strongly affects the ionizing radiation dose, are particularly important parameters in determining the extent of ionizing radiation crosslinking that the precursor undergoes.

Ionizing Radiation Exposure Time

The exposure or residence time using pulsed e-beam is less than that required when using a continuous e-beam. In order to achieve high conversion of monomer to (co)polymer (i.e., greater than about 90%) using pulses of accelerated electrons at the dose levels specified herein, a residence time of at least about 1 second, 1.5 seconds, 2, seconds, 3, seconds, 4 seconds, 5 seconds, 7.5 seconds, or even 10 seconds or greater. In some exemplary embodiments, the exposure time is at most 120 seconds, 100 seconds, 75 seconds, 50 seconds, 25 seconds, 20 seconds, 15 seconds, or even at most 10 seconds.

A number of different methods can be employed to provide the desired total dose and residence time for polymerization. One method employs a shuttle system communicating with an on-off switch for the electron beam generator that causes the substrate with the coating of precursor to remain stationary under the ionizing radiation window until the desired total dose of electron beam energy has been deposited. A second method employs a continuously moving conveyor belt to move the coated substrate under the ionizing radiation window at a speed calculated to deposit the desired total dose of ionizing radiation energy onto the precursor. A third method moves a continuous web of the precursor past an array of electron beam generators operated and positioned to provide the desired total dose of ionizing radiation energy across an extended surface area of the web.

Ionizing Radiation Dose

The dose (or equivalently, energy dose) is the total amount of ionizing radiation energy deposited per unit mass. Dose is commonly expressed in kilograys (kGy). A kilogray is defined as the amount of radiation required to supply 1 joule of energy per gram of mass.

The total dose received by a precursor primarily affects the extent to which the (co)polymers and comonomers are crosslinked. In general, it is desirable to convert at least 95 wt %, preferably 99.5 wt %, of the monomers and/or oligomers to (co)polymer. However, the conversion of monomers to (co)polymer in a solventless or low solvent system is asymptotic as the reaction progresses due to diffusion limitations inherent in such systems. As monomer concentration is depleted it becomes increasingly difficult to further polymerize the diffusion-limited monomers.

Dose is dependent upon a number of processing parameters, including voltage, speed and beam current. Dose can be conveniently regulated by controlling line speed (i.e., the speed with which the precursor passes under the e-beam window), the current supplied to the extractor grid, and the rate of the pulses of accelerated electrons. A target dose (e.g., 20 kGy) can be conveniently calculated by the KI=DS equation, where K is the machine constant, I is current (mA), D is dose in kilograys, and S is speed, in fpm or cm/sec. The machine constant varies as a function of beam voltage and cathode width.

Once a dose rate has been established, the absorbed dose is accumulated over a period of time. During this period of time, the dose rate may vary if the precursor is in motion or other absorbing objects pass between the source and the precursor. For any given piece of equipment and irradiation sample location, the dose delivered can be measured in accordance with ASTM E-1702 entitled “Practice for Dosimetry in a Gamma Irradiation Facility for Radiation Processing”. Dosimetry may be determined per ASTM E-1275 entitled “Practice for Use of a Radiochromic Film Dosimetry System” using GEX B3 thin film dosimeters.

In certain exemplary embodiments, the reaction mixture is exposed to ionizing radiation for a time sufficient to receive a dose of ionizing radiation up to 500 kiloGray (kGy), 400 kGy, 300 kGy, 200 kGy, 100 kGy, or even up to 90 kGy, up to 80 kGy, up to 70 kiloGray, up to 60 kGy, or up to 50 kGy. In further exemplary embodiments, the mixture is exposed to ionizing radiation for a time sufficient to receive a dose of ionizing radiation of at least 5 kGy, at least 10 kGy, at least 20 kGy, at least 25 kGy, at least 30 kGy, at least 40 kGy, or even at least 50 kGy.

Ionizing Radiation Dose Rate

In some exemplary embodiments where the electron beam is scanned and/or pulsed over the adhesive precursor on the major surface of the substrate in order to initiate crosslinknig, the radiation dose rate may also be important in determining the extent of crosslinking. Generally, the dose required to obtain the desired degree of crosslinking is proportional to the dose rate. At sufficiently low dose rates, a dose of 20 kGy will be sufficient but residence time may be too long to be practically maintained using e-beam. On the other hand, as dose rate is increased an excessively high dose will be required to overcome the higher rate of termination. For a conventional (continuous) e-beam, a dose on the order of 150-200 kGy may be required to achieve high conversion in a residence time on the order of 2 seconds. This will require a large power supply and may generate excessive heat. Furthermore, desired physical properties of the articles made by the present disclosure may be limited by the excessive crosslinking and grafting reactions as well as low molecular weight material that result from using a high dose.

In exemplary embodiments in which pulses of accelerated electrons are employed rather than a continuous e-beam, high conversion (crosslinking) results may be obtained at about the same total dose level as required for a continuous electron source, but in less time. For example, only about 2 seconds of residence time is generally required to achieve a specified degree of crosslinking using a pulsed e-beam, as opposed to about 5 seconds for continuous e-beam exposure at a dose of 80 kGy.

Dose rate may be calculated from the dose delivered to the sample (kGy) divided by the duration of the exposure to radiation in seconds (residence time). Residence time governs the dose required, which in turn determines the dose rate. The preferred dose per pulse is low. An optimum dose per pulse is about 10-30 Grays. At low dose per pulse, the excessive termination of propagating free radicals due to spatial overlap of e-beam produced tracks is avoided.

Inert Atmosphere

Ionizing radiation exposure of the precursor is preferably carried out in the presence of minimal amounts of oxygen, which is known to inhibit free-radical polymerization. Hence, e-beam irradiation of the precursor should be conducted in an inert atmosphere such as nitrogen, carbon dioxide, helium, argon, etc. Polymerization is preferably conducted, for example, in a nitrogen atmosphere containing up to about 3,000 parts per million (ppm) oxygen, preferably limited to 1,000 ppm oxygen, and more preferably 50 to 300 ppm oxygen, to obtain the most desirable adhesive properties. The concentration of oxygen can conveniently be measured by an oxygen analyzer.

Oxygen can be substantially excluded in making an adhesive, for example, by sandwiching the adhesive syrup between solid sheets of material (e.g., a tape backing and a release liner) and irradiating the adhesive syrup through the sheet material.

Temperature

Another parameter that influences the degree of crosslinking is the temperature of the adhesive precursor during crosslinking. Thus, in some exemplary embodiments, it may be desirable to maintain the adhesive precursor at low temperatures during crosslinking (co)polymerization or curing. Superior adhesive properties and high conversion were achieved for pressure sensitive adhesives by cooling the adhesive syrup for a pressure-sensitive adhesive to a temperature below 20° C., preferably below 10° C. and most preferably below 5° C. The temperature was preferably maintained between about −80° C. to 10° C. and most preferably between about 0 to 5° C., as described in U.S. Pat. No. 6,232,365, which is incorporated herein by reference in its entirety.

It is believed that by conducting polymerization using a continuous beam of accelerated electrons at temperatures below 20° C., the rate of (co)polymer chain propagation is increasingly favored over the rate of termination, with the effect of producing polymers with a higher gel content and higher conversion.

When using the pulses of accelerated electrons, similar advantages have been found at low temperatures, because pulsing allows the use of instantaneously high dose rates per pulse. Low temperature increases the viscosity of the system. When the viscosity is increased, the diffusion of free radicals is slowed. This helps to isolate the free radicals, reduce termination, and allow for more polymerization. Therefore, the temperature is preferably maintained at a low temperature during the present inventive process to make pressure sensitive adhesive articles. However, it is not necessary, but may be beneficial, to maintain the low temperature for the production of other articles (i.e. coatings) using the inventive process. In the alternative, for articles other than pressure sensitive adhesives, it may be beneficial to keep the temperature low for about the first 40-80%, and preferably 50-70%, of the reaction time. It is also known that higher levels of crosslinker (1%) may be used to off-set the need for low temperatures by speeding up the rate of conversion. However, if higher levels of crosslinker are used to make a pressure-sensitive adhesive article, the adhesive physical properties may be limited.

The term “low temperature” refers to any temperature below ambient, which can be consistently maintained, and which is below about 20° C. However, there are increasing advantages with lower temperatures down to −70° C. (obtained for example, using dry ice).

The temperature of the precursor can be maintained at the desired low temperature during polymerization, or a portion of the polymerization time, by a variety of techniques, such as introducing chilled nitrogen gas into the radiation chamber, placing the coated precursor upon a cooling plate, or use of any other type of heat sink or chilled drum.

Conditions that are optimum for pulsed polymerizations appear to be more dependent on temperature control than for continuous, possibly due to the higher instantaneous dose rate of a single pulse and the need to limit diffusion to prolong the heterogeneous mode. Thus, in any of the foregoing embodiments, irradiating with pulses of accelerated electrons from a pulsed electron beam occurs at a temperature below 20° C.

Using a scanned, pulsed electron beam polymerization process results in clear benefits over continuous radiation polymerization, as polymerization of monomers without excessive and premature crosslinking becomes feasible at reasonable process speeds. Additionally, use of scanned, pulsed e-beam polymerization generally improves (co)polymer chain grafting and crosslinking, thereby strengthening the (co)polymer sufficient for use as a hardcoat.

### Crosslinked Pressure Sensitive Adhesives

Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength. Materials that have been found to function well as pressure sensitive adhesives are polymers designed and formulated to exhibit the requisite viscoelastic properties resulting in a desired balance of tack, peel adhesion, and shear holding power.

In an advantageous aspect of the radiation crosslinkable pressure sensitive adhesive precursor, the amount of (meth)acrylate base (co)polymer, (co)polymerized crosslinker, (co)polymerized hydrogen-donating monomer and hydrocarbon tackifier are selected such as to provide the radiation crosslinked pressure sensitive adhesive obtained by e-beam or gamma radiation crosslinking, with a static shear at 70° C. of at least 2000 minutes, preferably at least 4000 minutes, more preferably at least 6000 minutes, even more preferably at least 8000 minutes, still more preferably at least 10000 minutes, when measured according to static shear test ASTM D3654.

In an advantageous aspect, the static shear at 70° C. is measured on an e-beam or gamma radiation crosslinked pressure sensitive adhesive layer coated on a liner and applied onto a substrate, wherein the thickness of the pressure sensitive adhesive layer is varied between about 25 μm and about 100 μm.

Advantageously, the e-beam or gamma radiation crosslinkable pressure sensitive adhesive precursor is hot melt processable. However, the various embodiments of the present disclosure are not limited to such radiation crosslinkable pressure sensitive adhesive precursors since, according to another advantageous aspect, the radiation crosslinkable pressure sensitive adhesive precursor may be provided as a solvent borne adhesive system, which is therefore solvent processable, or as a water based system.

Hot melt processable radiation crosslinkable pressure sensitive adhesive precursors are typically hot melt mixed blends comprising a (meth)acrylate base (co)polymer, a (co)polymerized hydrogen-donating monomer, and a tackifying resin, in an amount greater than 40 parts by weight per 100 parts by weight of (meth)acrylate base (co)polymer. Typically, the hot melt processable radiation crosslinkable pressure sensitive adhesive precursor may further comprise a thermoplastic material.

The hot melt processable radiation crosslinkable pressure sensitive adhesive precursors can be prepared by a variety of hot melt techniques. Generally, the methods comprise providing a hot melt mixing apparatus, providing an (meth)acrylate base (co)polymer, a (co)polymerized crosslinker in a amount greater than 0.10 parts by weight per 100 parts by weight of (meth)acrylate base (co)polymer, a (co)polymerized hydrogen-donating monomer, and providing greater than 40 parts by weight per 100 parts by weight of (meth)acrylate base (co)polymer of a tackifying resin in an amount, mixing the (meth)acrylate base (co)polymer, the (co)polymerized crosslinker, the (co)polymerized hydrogen-donating monomer and the tackifying resin in the hot melt mixing apparatus to prepare a hot melt blend, removing the blend from the hot melt mixing apparatus to form a hot melt processable pressure sensitive adhesive.

A variety of hot melt mixing techniques using a variety of hot melt mixing equipment are suitable for preparing the hot melt processable pressure sensitive adhesive precursors and hot melt processable pressure sensitive adhesives. Both batch and continuous mixing equipment may be used. Examples of batch methods include those using a BRABENDER (e. g. a BRABENDER PREP CENTER, commercially available from C.W. Brabender Instruments, Inc.; South Hackensack, N.J.) or BANBURY internal mixing and roll milling equipment (e.g. equipment available from Farrel Co.; Ansonia, Conn.).

Examples of continuous methods include single screw extruding, twin screw extruding, disk extruding, reciprocating single screw extruding, pin barrel single screw extruding, planetary extruding, and ring extruding. Continuous methods can utilize distributive elements, pin mixing elements, static mixing elements, and dispersive elements such as MADDOCK mixing elements and SAXTON mixing elements. A single hot melt mixing apparatus may be used, or a combination of hot melt mixing equipment may be used to prepare the hot melt blends and the hot melt processable pressure sensitive adhesives. In some embodiments, it may be desirable to use more than one piece of hot melt mixing equipment. For example, one extruder, such as, for example, a single screw extruder, can be used to hot melt process the hot melt processable elastomeric (meth)acrylate random copolymer contained within a thermoplastic pouch. The output of this extruder can be fed into a second extruder, for example, a twin screw extruder for hot melt mixing with the additional components. The hot melt blends described above are used to form hot melt processable pressure sensitive adhesives upon completion of the hot melt blending process.

The output of the hot melt mixing is coated onto a substrate to form an adhesive layer. If a batch apparatus is used, the hot melt blend can be removed from the apparatus and placed in a hot melt coater or extruder and coated onto a substrate. If an extruder is used to prepare the hot melt blend, the blend can be directly extruded onto a substrate to form an adhesive layer in a continuous forming method. In the continuous forming method, the adhesive can be drawn out of a film die and subsequently contacted to a moving plastic web or other suitable substrate. If the adhesive is to be part of a tape, the substrate may be a tape backing. In some methods, the tape backing material is coextruded with the adhesive from a film die and the multilayer construction is then cooled to form the tape in a single coating step. If the adhesive is to be a transfer tape, the adhesive layer may be a free standing film and the substrate may be a release liner or other releasing substrate. After forming, the adhesive layer or film can be solidified by quenching using both direct methods (e.g. chill rolls or water batch) and indirect methods (e.g. air or gas impingement).

### Optional Pressure Sensitive Adhesive Additives

As described below, a variety of additional additives can be included in the hot melt blend including one or more plasticizers, crosslinkers, UV stabilizers, antistatic agents, colorants, antioxidants, fungicides, bactericides, organic and/or inorganic filler particles, and the like. Optionally, low levels of plasticizer (e.g., less than about 10 parts by weight) may be added to the hot melt blend.

In particular, a wide variety of commercially available materials described as “plasticizers” are suitable, as long as the added plasticizer is compatible with the other components of the hot melt blend. Representative plasticizers include dialkyl adipate, di(2-ethylhexyl) adipate, dibutoxyethoxyethyl formal, and dibutoxyethoxyethyl adipate.

### Pressure Sensitive Adhesive Articles

In still another aspect, the present disclosure relates to the use of an ionizable radiation crosslinkable pressure sensitive adhesive precursor as above described, for the manufacture of adhesive articles, such as single-sided or double-sided adhesive tapes, often provided in rolled form, or adhesive labels. In various exemplary embodiments, the rolls of adhesive coated substrates of the present disclosure may be rolls of an adhesive tape that includes a backing layer and an adhesive coating disposed on a major surface of the backing layer. Common types of adhesive tapes include masking tape, electrical tape, duct tape, filament tape, medical tape, transfer tape, and the like.

The adhesive tape rolls may further include a release coating, or low adhesion backsize, disposed on a second major surface. Alternatively, the adhesive tape rolls may include a release liner (which may have a release coating disposed on a major surface thereof) in contact with the adhesive coated major surface of the backing layer. As another example, an adhesive tape roll may include a release liner comprising a release coating disposed on at least a portion of each of its major surfaces and an adhesive coating deposited over one of the release coatings.

Examples of suitable backing layers include, without limitation, CELLOPHANE, acetate, fiber, polyester, vinyl, polyethylene, polypropylene including, e.g., monoaxially oriented polypropylene and biaxially oriented polypropylene, polycarbonate, polytetrafluoroethylene, polyvinylfluoroethylene, polyurethane, polyimide, paper (e.g., Kraft paper), woven webs (e.g., cotton, polyester, nylon and glass), nonwoven webs, foil (e.g., aluminum, lead, copper, stainless steel and brass foil tapes) and combinations thereof.

The backing layers and release liners, can also include reinforcing agents including, without limitation, fibers, filaments (e.g., glass fiber filaments), and saturants (e.g., synthetic rubber latex saturated paper backings).

In certain exemplary embodiments of the present disclosure, the ionizing radiation crosslinkable pressure sensitive adhesive precursor may be coated on the substrate using any conventional technique known in the art, such as e.g., solution coating, coextrusion coating, solventless coating, waterborne coating, hot melt coating, and any combinations thereof.

### Exemplary Advantages of Ionizing Radiation Crosslinking

Exemplary embodiments of the present disclosure may have advantages over use of actinic radiation (e.g. ultraviolet radiation, and the like) to initiate crosllinking of the precursor. One such advantage of exemplary embodiments of the present disclosure is that the polymerization process is effective for quickly and efficiently producing polymers having a sufficient crosslink density to perform well as a pressure sensitive adhesive. Pressure-sensitive adhesive compositions generally require superior peel adhesion and superior shear strength and high conversion, which does not require the use of solvents or chemical initiators for the conversion process to take place.

A second advantage of at least one exemplary embodiment of the present disclosure is that the deposition of energy by the pulses of accelerated electrons obtained using a pulsed electron beam under certain conditions (e.g., low dose/pulse and high pulse rate), is heterogeneous in nature. Thus, in any of the foregoing exemplary embodiments, the precursor may be crosslinked or (co)polymerized heterogeneously in a single phase. Heterogeneous polymerization (polymerization in heterogeneous mode or fashion) occurs when free radicals are localized (non-random) by any of several mechanisms involving different states of matter or phase separation within a given state of matter in order to restrict their diffusion. This has the effect of limiting termination reactions. In contrast, in homogeneous polymerization, the diffusion of monomer to the free radicals is not restricted. Termination results from a propagating free radical being joined by another free radical, rather than a monomer, to effectively end propagation. The two unpaired electrons combine to form a single bond.

The ionization events, in heterogeneous polymerization, are distributed at some distance from one another as isolated sites where free radicals emerge as surviving species before diffusion causes the system to become homogeneously distributed. This effectively allows polymerization to take place and reduces termination because the free radicals are separated from each other spatially for a short time period. The reduction in termination results in higher conversion values for the polymerization method.

Homogeneous polymerization (or polymerization in a homogeneous fashion or mode), on the other hand, is polymerization in which the free radicals are distributed randomly in a single-phase medium and are free to diffuse. The termination that results is governed by the thermodynamics of movement (which is continuous zigzag motion of the molecules caused by impact with other molecules of the liquid). Termination effectively occurs more easily and quickly than in heterogeneous polymerization.

Another advantage of at least one embodiment of the present disclosure is that the residence time needed to produce an article using the method is shorter, because of reduced terminations, than using the other methods of irradiation or a continuous beam of electrons. This means that more practical throughput rates can be achieved. The reduced residence time results, in part, from the increased conversion efficiency of the monomers, comonomers and oligomers in the precursor, In some exemplary presently preferred embodiments, the conversion efficiency of the precursor is greater than 90%, more preferably greater than 92%, even more preferably greater than 95%, more preferably still greater than 98% or even 99%. Optionally, the gel percent is greater than 95%, more preferably greater than 96%, 97%, 98%, or even 99%.

A further advantage of at least one embodiment of the present disclosure is that pulsing the electron beam decreases the high voltage hold-off (i.e. using more robust insulation around the cathode and high voltage components) required by continuous e-beams to prevent internal arching. Therefore, there may be the opportunity to lower capital cost to build equipment by using less expensive components and more compact vessels.

An additional advantage, in some exemplary embodiments, is the tolerance for longer or wider pulse duration or pulse width than is typical of thyratron types of pulse forming equipment (1-2 microseconds). The tolerance of pulse durations of about 1-250 microseconds allows latitude in the choice of pulse-forming networks which include less expensive, more conventional capacitor-discharge types. Also, there is less thermal shock experienced by the beam window at the wider pulse-width.

Another advantage in at least one exemplary embodiment over the UV initiated crosslinking process is that a clean and clear adhesive can be made without the photoinitiators or triazine residues. Also, highly pigmented adhesives can be produced that would not be able to be produced by UV because they are opaque to UV light.

Yet another advantage of at least one embodiment of the present disclosure is that it allows for polymerization of materials with short stability times, because the process is so fast. For instance, polymerization of a mixture of two immiscible materials is possible. The mixture can be polymerized after it has been mixed and before it has a chance to phase separate. In addition, polymerization of thin layers of materials that evaporate quickly after being coated is also possible. Further, because temperature control can be practically maintained throughout the short time period necessary for polymerization, it is possible to (co)polymerize biphase compositions with novel morphology or topology.

An additional advantage of exemplary embodiments of the present disclosure is that there are fewer contaminants than with other processes. In other processes for making a pressure-sensitive adhesive, for example, catalysts or initiators are used to make the adhesive. The initiator, or parts of it, remains in the adhesive that is formed using the initiator. It is important, in the electronics industry, for example, to keep these contaminants to a minimum. When adhesives, for example, are used in or near electronics, any contaminants in the adhesives or out-gas may cause undesirable reactions in the electronics, such as corrosion. The pulsed e-beam process does not use initiators, and, therefore, eliminates this problem.

One more advantage of at least one exemplary embodiment of the present disclosure is that it is versatile. For example, the method may be used to polymerize solventless blends as well as emulsions, which may be coated on-web and then polymerized.

The uncured precursor may be exposed to the source of ionizing radiation from one side through the release liner. For making a single layer laminating adhesive type tape, a single pass through the source of ionizing radiation may be sufficient. Thicker samples, may exhibit a cure gradient through the cross section of the adhesive so that it may be desirable to expose the uncured material to the source of ionizing radiation from both sides.

Various exemplary embodiments illustrating the features and advantages of the present disclosure will be further described with regard to the following detailed Examples. These examples are offered to further illustrate the various general and preferred embodiments and techniques. It should be understood, however, that many variations and modifications may be made while remaining within the scope of the present disclosure.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Summary of Materials

Unless otherwise noted, all parts, percentages, ratios, etc. in the Examples and the rest of the specification are by weight. Solvents and other common reagents used may be obtained from Sigma-Aldrich Chemical Company (Milwaukee, Wis.) unless otherwise noted. In addition, Table 1 provides abbreviations and a source for all materials used in the Examples below:

TABLE 1
List of Materials

| Designation | Description | Supplier |
|---|---|---|
| IOA | Isooctyl acrylate | 3M |
| AA | Acrylic Acid | BASF |
| ABP | 4-Acryloxybenzophenone | 3M |
| Irgacure 651 | 2,2-Dimethoxy-1,2-diphenylethan-1-one | BASF |
| Regalite ™ | Hydrocarbon Resin, partially hydrogenated | Eastman |
| R7100 | water-white inert thermoplastic resin derived | |
| | from petrochemical feedstocks. | |
| TMPTMA | Trimethylolpropane Trimethacrylate | Sartomer (as |
| | | SR350) |

### Test Methods

The following test methods have been used in evaluating some of the Examples of the present disclosure. Unless otherwise indicated, prior to testing all adhesives were conditioned at ambient conditions (23° C.+/−2° C. and 50%+/−5% relative humidity) during 12 hours Alternative, as indicated in the examples, the adhesives were aged during one week in an air circulated oven at 70° C. prior to testing.

1. 90° Peel Tests

90° Peel tests were performed on aluminum, polypropylene, and STA-211 polyethylene. STA-211 is a standard polyethylene (PE) test surface, for testing, STA-211 foil having a thickness of 13 mils (330 μm) and a rough and a smooth side was fixed on an aluminum plate having a dimension of 150 mm×50 mm×2 mm, using a double sided adhesive tape for fixation. The PE film made from polyethylene (PE) pellets being available under trade designation “VORIDIAN POLYETHYLENE 1550P” from Eastman Chemical Co. (Kingsport, Tenn., USA). The test was performed only on the smooth side. Cotton gloves were used during preparation of STA211 covered aluminum panels in order to avoid surface contamination. The surface was used without further cleaning.

The PP test panels were not-coloured panels obtained under the trade designation SIMONA DWST from ROCHOLL Gmbh. Prior to use, the Aluminum test panels were cleaned by wiping the panels with a lint free tissue first with a pass of methyl ethyl ketone (MEK), followed by a wipe with n-heptane and finally another pass with methyl ethyl ketone (MEK). Wiping of the panels per pass of solvent was always done until dryness. PP panels were cleaned once with a 90/10 mixture of isopropyl alcohol (IPA) and water.

In a climate room set at ambient conditions (23° C.+/−2° C. and 50%+/−5% relative humidity), 1 inch (2.54 cm) wide adhesive strips having a length of approximately 300 mm were cut from the conditioned samples using a specimen cutter holding two single-edged razor blades in parallel planes of the adhesive. The strip was placed without pressure onto a (cleaned) test panel, after which the strip was fixed onto the test panel using a 2 kg hand-held rubber-covered roller at a rate of 10+/−0.5 mm/s with 2 passes in each direction. After a dwell time of 24 hours in the climate room, a 90° peel test was performed using a FP-2255 Peel Tester (manufactured by Thwing-Albert Instrument Company). The adhesive strip was pulled at a speed of 300 mm/min. Three measurements were made per example and the average recorded in N/inch.

2. Static Shear Strength on Stainless Steel (SS)

The static shear strength test method determines the ability of pressure-sensitive adhesive tapes to remain adhered under constant load applied parallel to the surface of the tape and substrate. The test was performed according to ASTM D 3654 (published in 2006.)

Static shear strength was measured on stainless steel panels, with bright annealed finish (in accordance with Specification ASTM A666, published in 2010) having a dimension of 50 mm by 125 mm (and a minimum thickness of 1.1 mm). Prior to use, the stainless steel panels were cleaned by wiping the panels with a lint free tissue first with a pass of methyl ethyl ketone (MEK), followed by a wipe with n-heptane and finally another pass with methyl ethyl ketone (MEK). Wiping of the panels per pass of solvent was always done until dryness.

A 1 inch (2.54 cm) wide strip of adhesive was cut from the tape by using a specimen cutter holding two single-edge razor blades in parallel planes, the blades spaced 1 inch (2.54 cm) apart. The adhesive strip was then placed onto a clean stainless steel panel covering a 1 inch by 1 inch (2.54 cm×2.54 cm) area of the stainless steel panel. The adhesive strip was then over-rolled twice in each direction using a hand-held rubber-covered 2 kg hand-roller at an approximate rate of 10 mm+/−0.4 mm/s. The test was performed after a dwell time of 24 hours.

A 1 kg weight was used as the static load and the test samples were placed on an automated timing apparatus in an air conditioned room at ambient conditions (23° C.+/−2 ° C. and 50%+/−5% relative humidity). The time when the load dropped was recorded (min). When the load did not fall down after 10000 min, the test was discontinued and the result identified as 10000+. Failure modes are given in brackets. In case samples did not fall down after 10,000 min, the slippage from its original position was recorded and given in brackets. The data reported are the averages of three measurements.

3. Molecular Weight Determination from Inherent Viscosity

An approximate molecular weight of the (meth)acrylate base (co)polymers were determined by measuring the inherent viscosity, according to ASTM D 2857. The inherent viscosity was measured on a 0.3 g/dl solution of the (meth)acrylate base (co)polymer in ethyl acetate, at 25° C., using a Canon-Fenske capillary viscometer as described in the copending U.S. Patent Application Ser. No. 62/095,397, filed Dec. 22, 2014 and titled “Tackified Acrylate Pressure Sensitive Adhesives with Low Acid Content,” which is incorporated herein by reference in its entirety. The values of inherent viscosity are expressed in dl/g.

### Examples E1-E6 and Comparative Examples C1 and C2

The following examples illustrate the preparation of various ionizing radiation crosslinkable adhesive precursors and crosslinked pressure sensitive adhesives according to the present disclosure, as well as certain comparative examples.

### (Meth)Acrylate Base (Co)Polymers

Examples E1-E6 and comparative examples C1 and C2 were prepared from solutions of (meth)acrylate base (co)polymers B0 and B 1, produced via solution polymerization, in a solvent mixture of ethyl acetate/heptane (typically in a ratio of 85/15), at 45 wt. % solids. The (meth)acrylate monomers, with acrylic acid, and optional copolymerizable crosslinker were dissolved in the solvent mixture and allowed to polymerize. The polymerization was initiated by an azo initiator (VAZO 601, commercially available from WAKO Chemical Co. (Wilmington, Del.)); 0.2% by weight, based on the monomers) and the mixture was polymerized under constant stirring for 20 hours at 60° C. After polymerization, the inherent viscosity was measured as described in application Ser. No. 62/095,397. The composition of (meth)acrylate base (co)polymers is provided in Table 1. IV denotes the inherent viscosity of the precursor (co)polymer solution.

TABLE 2
Composition Of (Meth)acrylate Base Polymers
(Amounts in Weight Percent)

| (Meth)acrylate | | | | |
|---|---|---|---|---|
| Base | | | | |
| (Co)polymer | IOA | AA | ABP | IV (dl/g) |
| B0 | 99.5 | 0.5 | 0 | 0.94 |
| B1 | 99.4 | 0.5 | 0.1 | 0.95 |

### Radiation Crosslinked Pressure Sensitive Adhesives

The pressure sensitive adhesives were prepared from a blend containing 100 parts (meth)acrylate base (co)polymer, 60 parts Regalite® R7100 hydrocarbon tackifier, and TMPTMA as an optional crosslinkable (co)polymerizable compound. Adhesive layers were made by knife coating the solvent based mixture onto a white, double-sided siliconized paper liner available from Mondi Akrosil (Pleasant Prairie, Wis.) at a wet thickness of 75 μm.

The coatings were dried at room temperature during 6 minutes, followed by drying at 85° C. during 7 minutes. The coating thickness of the dried adhesive layer was 100 μm+/−2 μm. Test specimen were prepared for the 90° Peel Adhesion and Static Shear measurements as described in the following.

Comparative examples C1-C2 were UV crosslinked with 700 mJ/cm² of total UV (sum of UV-A, UV-B 20 and UV-C; measured with a Power Puck from EIT, Inc. (Sterling, Va.) under a medium pressure mercury lamp available from TCS Technologies, Inc. (Hackettstown, N.J.).

Examples E1 to E6 were crosslinked using ionizing radiation, more specifically electron beam radiation. The coated adhesive samples were e-beamed using 80-300 kV e-beam equipment commercially available from Electron Crosslinking AB (Nehren, Germany). The nitrogen gap was adjusted to 30 mm.

The adhesives were irradiated from the open face side with an e-beam. An acceleration tension of 190 kV was used, providing the best ionization profile for 100 g/m² coatings. The adhesive sheets were irradiated with a 100 kGy, 150 kGy, or 200 kGy dose, as indicated in Table 3, below. After curing, the pressure sensitive adhesives were laminated on a 50 μm thick PET liner. The liner side was always used for measuring adhesive properties (90° Peel and Static Shear as indicated in Table 4, below.

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

TABLE 3
Crosslinked Pressure Sensitive Adhesives

| | Acrylic | | | | | | |
|---|---|---|---|---|---|---|---|
| | (Co)(co)polymer | | Tackifier | | Added Crosslinker | | Crosslinking |
| | Identifier (ID) | Wt. % | ID | Wt. % | ID | Wt. % | Method |
| C1 | B0 | 62.5 | R7100 | 37.5 | — | | UV |
| C2 | B1 | 62.5 | R7100 | 37.5 | — | — | UV |
| E1 | B0 | 62.5 | R7100 | 37.5 | — | — | Ebeam 100 kGy |
| E2 | B0 | 62.5 | R7100 | 37.5 | — | — | Ebeam 150 kGy |
| E3 | B0 | 62.5 | R7100 | 37.5 | — | — | Ebeam 200 kGy |
| E4 | B1 | 62.5 | R7100 | 37.5 | — | — | Ebeam 100 kGy |
| E5 | B0 | 62.1 | R7100 | 37.3 | TMPTMA | 0.6 | Ebeam 100 kGy |

TABLE 4
90° Peel and Static Shear Test Results

| | | | | Static |
|---|---|---|---|---|
| | 90° Peel from: | | | Shear |
| | | Poly | Polyethylene | from: |
| | | propylene | (PE) | Stainless |
| | Aluminum | (PP) | STA211 | Steel |
| | (N/inch) | (N/inch) | (N/inch) | (min) |
| C1 | 36.9 | 39.5 | 21.5 | 19 |
| | | | | (cohesive |
| | | | | failure) |
| C2 | 29.5 | 37.3 | 19.6 | 372 |
| | | | | (cohesive |
| | | | | failure) |
| E1 | 32.1 | 40.9 | 21.2 | 10,000+ |
| | | | | (2 mm |
| | | | | slip) |
| E2 | 25.1 | 37.7 | 17.0 | 10,000+ |
| | | | | (1 mm |
| | | | | slip) |
| E3 | 15.6 | 30.5 | 11.9 | 10,000+ |
| | | | | (<1 mm |
| | | | | slip) |
| E4 | 19.9 | 37.4 | 17.6 | 10,000+ |
| | | | | min (no |
| | | | | slip) |
| E5 | 19.7 | 33.7 | 12.8 | 10,000+ |
| | | | | (no slip) |

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.”

Furthermore, all publications and patents referenced herein are incorporated by reference in their entirety to the same extent as if each individual publication or patent was specifically and individually indicated to be incorporated by reference.

Various exemplary embodiments have been described. These and other embodiments are within the scope of the following claims.

1. An ionizing radiation crosslinkable pressure sensitive adhesive precursor comprising:
a (meth)acrylate base (co)polymer;
a hydrocarbon tackifying resin in an amount greater than 40 parts by weight per 100 parts by weight of the (meth)acrylate base (co)polymer; and optionally
a (co)polymerized hydrogen-donating monomer,
wherein the adhesive precursor has a total acid content of from 0 wt. % to not more than 3 wt. % by weight of the adhesive precursor, optionally wherein the adhesive precursor is substantially free of catalysts, thermal initiators, and photoinitiators.

2. The adhesive precursor of claim 1, further comprising at least one crosslinkable (co)polymerizable compound capable of crosslinking with at least one component of the adhesive precursor mixture, wherein the at least one crosslinkable (co)polymerizable compound comprises at least one carbon to carbon double bond, optionally wherein the crosslinkable (co)polymerizable compound is a multifunctional (meth)acrylate.

3. The adhesive precursor of claim 2, wherein the at least one crosslinkable (co)polymerizable compound is a multifunctional (meth)acrylate selected from trimethylolpropane tri(meth)acrylate, propoxylated trimethylolpropane triacrylates, ethoxylated trimethylolpropane triacrylates, tris(2-hydroxy ethyl)isocyanurate triacrylate, pentaerythritol triacrylate. ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylate, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, urethane di(meth)acrylates, and combinations thereof.

4. The adhesive precursor claim 1, wherein the (co)polymerized hydrogen-donating monomer is present as a (co)monomer in a crosslinking (co)polymer that is distinct from the (meth)acrylate base (co)polymer.

5. The adhesive precursor of claim 1, wherein the amount of hydrocarbon tackifying resin is greater than 80 parts weight of (meth)acrylate base (co)polymer.

6. The adhesive precursor of claim 1, wherein the amount of the crosslinkable (co)polymerizable compound is from 0.18 to 0.7 parts by weight per 100 parts by weight of the (meth)acrylate base (co)polymer.

7. The adhesive precursor of claim 1, wherein the (co)polymerized hydrogen-donating monomer is present in an amount from 0.1 to 3 parts by weight per 100 parts by weight of the (meth)acrylate base (co)polymer.

8. The adhesive precursor of claim 7, wherein the (co)polymerized hydrogen-donating monomer is selected from the group consisting of (meth)acrylamide, (meth)acrylate monomers containing at least one nitrogen functional group, urethane (meth)acrylate monomers containing at least one nitrogen functional group, vinylic monomers containing at least one nitrogen functional group, and combinations thereof.

9. The adhesive precursor of claim 8, wherein the (co)polymerized hydrogen-donating monomer is selected from the group consisting of N,N-dimethyl (meth)acrylamide; N,N-diethyl (meth)acrylamide; N-vinyl caprolactam; N-Vinylpyrrolidone; N-isopropyl (meth)acrylamide; N,N-dimethylaminoethyl (meth)acrylate; 2-[[(Butylamino)carbonyl]oxy]ethyl (meth) acrylate N,N-dimethylaminopropyl (meth)acrylamide; N,N-diethylaminopropyl (meth)acrylamide; N,N-diethylaminoethyl (meth)acrylate; N,N-dimethylaminopropyl (meth)acrylate; N,N-diethylaminopropyl (meth)acrylate; N,N-dimethylaminoethyl (meth)acrylamide; N,N-diethylaminoethyl (meth)acrylamide; (meth)acryloyl morpholine, vinylacetamide and any combinations or mixtures thereof.

10. An adhesive comprising a crosslinked form of the adhesive precursor of claim 1.

11. An article comprising the adhesive of claim 10.

12. The article of claim 11, further comprising one or more adherends.

13. The article of claim 12, wherein the article is an adhesive tape.

14. The article of claim 12, wherein the article is an adhesive label.

15. The article of claim 11, wherein the article further comprises a release liner.

16. A method of making a crosslinked adhesive, comprising:
providing an adhesive precursor mixture further comprising:
a (meth)acrylate base (co)polymer;
a hydrocarbon tackifying resin in an amount greater than 40 parts by weight per 100 parts by weight of the (meth)acrylate base (co)polymer; and optionally
a (co)polymerized hydrogen-donating monomer,
wherein the adhesive precursor mixture has a total acid content of from 0 wt. % to not more than 3 wt. % by weight of the adhesive precursor, optionally wherein the adhesive precursor mixture is substantially free of catalysts, thermal initiators and photoinitiators; and
exposing the adhesive precursor mixture to a source of ionizing radiation for an exposure time sufficient to achieve an energy dose sufficient to at least partially crosslink the adhesive precursor mixture to form a pressure sensitive adhesive, optionally wherein the source of ionizing radiation is selected from an electron beam, a source of gamma radiation, or a combination thereof.

17. The method of claim 16, wherein the adhesive precursor mixture further comprises at least one crosslinkable (co)polymerizable compound capable of crosslinking with at least one component of the adhesive precursor mixture, wherein the at least one crosslinkable (co)polymerizable compound comprises at least one carbon to carbon double bond, optionally wherein the crosslinkable (co)polymerizable compound is a multifunctional (meth)acrylate.

18. The method of claim 17, wherein the at least one crosslinkable (co)polymerizable compound is a multifunctional (meth)acrylate selected from trimethylolpropane tri(meth)acrylate, propoxylated trimethylolpropane triacrylates, ethoxylated trimethylolpropane triacrylates, tris(2-hydroxy ethyl)isocyanurate triacrylate, pentaerythritol triacrylate. ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylate, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, urethane di(meth)acrylates, and combinations thereof.

19. The method of claim 16, wherein the ionizing radiation energy dose is at least 50 kGy, optionally wherein the ionizing radiation energy dose is no more than 500 kGy.

20. The method of claim 19, wherein the ionizing radiation exposure time is at least 1 second, optionally wherein the ionizing radiation exposure time is no more than 120 seconds.
